(19) United States
(12) Patent Application Publication
(10) Pub. No.: US 2021/0237477 A1
(43) Pub. Date: Aug. 5, 2021

(54) PRINTING APPARATUS, PRINTING METHOD, AND STORAGE MEDIUM

(71) Applicant: CANON KABUSHIKI KAISHA, Tokyo (JP)

(72) Inventors: Rie Takekoshi, Kanagawa (JP); Takayuki Ushiyama, Chiba (JP); Keita Ishimi, Kanagawa (JP); Tatsuo Shimmoto, Tokyo (JP); Masaya Uetsuki, Kanagawa (JP)

(21) Appl. No.: 17/163,097

(22) Filed: Jan. 29, 2021

(30) Foreign Application Priority Data
Feb. 4, 2020 (JP) 2020-017180

(51) Int. Cl. B41J 11/00; B41J 2/05; B41J 2/505

(52) U.S. Cl. CPC B41J 11/002; B41J 11/007; B41J 2/5056; B41J 2/05

(57) ABSTRACT

A printing apparatus includes a conveyance unit, a printing unit, and a heating unit that heats a print medium. The conveyance unit conveys the print medium such that the printing unit can print an image onto a second print region at a printing position when the heating unit can heat a first print region at a heating position. If the ink amount applied to the first print region is a first amount, an image is printed onto the second print region in a first mode. If the applied ink amount is a second amount larger than the first amount, an image is printed onto the second print region in a second mode. A time for which the first print region passes through the heating position in the second mode is longer than a time for which the first print region passes through the heating position in the first mode.

### BACKGROUND

### Field

The present disclosure relates to a printing apparatus and a printing method for printing an image by ejecting an ink onto a print medium, and a storage medium.

### Description of the Related Art

In recent years, there has been an increasing demand for performing printing using an inkjet printing method on a print medium with no ink permeability such as a polyvinyl chloride sheet (hereinafter referred to as “PVC sheet”) used for commercial and publication printing. As an inkjet printing apparatus to satisfy such a demand, a printing apparatus has been known which promotes the evaporation of a solvent contained in ink droplets on a print medium by means of air blow, heating, or the like to fix a color material onto the surface of the print medium.

Japanese Patent Laid-Open No. 2015-205999 discloses a technique in which a pigment ink having landed on a non-permeable print medium is heated by a heating apparatus to be fixed.

However, with the inkjet printing apparatus disclosed in Japanese Patent Laid-Open No. 2015-205999, the color material in a region where the total ink application amount is large may fail to be sufficiently fixed to the surface of the print medium. In this case, defective fixing that leads to detachment from the surface of the print medium (defective scratch resistance) occurs. If the heating temperature of the heating unit is set high in order to prevent the defective scratch resistance, excessive heat may be applied. Consequently, the PVC sheet may get stretched or shrunk and become wavy, thereby lowering the image quality and the appearance quality of the printed product.

### SUMMARY

The present disclosure provides a technique capable of printing an image having locally different ink application amounts with proper quality.

According to an aspect of the present disclosure, a printing apparatus includes a conveyance unit configured to convey a print medium in a conveyance direction, a printing unit configured to print an image by applying ink onto the print medium, a heating unit that is disposed downstream of the printing unit in the conveyance direction and configured to heat the print medium onto which the ink has been applied by the printing unit, an obtaining unit configured to obtain, for each print region of a plurality of print regions on the print medium lying side by side in the conveyance direction, a piece of application information indicating an amount of ink to be applied to the print region, wherein the plurality of print regions includes a first print region and a second print region, each indicated by a corresponding piece of application information, and a control unit configured to control, based on the pieces of application information, a printing operation to be performed by the printing unit to print images onto the plurality of print regions, wherein the conveyance unit conveys the print medium such that the printing unit is able to print the image onto the second print region at a printing position when the heating unit is able to heat the first print region at a heating position, wherein, in a case where the amount of ink applied to the first print region indicated by the corresponding piece of application information is a first amount, the control unit controls the printing operation to print the image onto the second print region in a first printing mode, wherein, in a case where the amount of ink applied to the first print region indicated by the corresponding piece of application information is a second amount larger than the first amount, the control unit controls the printing operation to print the image onto the second print region in a second printing mode, wherein each region onto which an image is printed in a printing mode is a predetermined region, and wherein a time for which the first print region passes through the heating position in a case where the image is printed onto the second print region in the second printing mode is longer than a time for which the first print region passes through the heating position in a case where the image is printed onto the second print region in the first printing mode.

According to the present disclosure, it is possible to print an image having locally different ink application amounts with proper quality while suppressing decrease in productivity.

Further features of the present disclosure will become apparent from the following description of exemplary embodiments with reference to the attached drawings.

### BRIEF DESCRIPTION OF THE DRAWINGS

FIG. 1 is a perspective view illustrating a main part of a serial-type printing apparatus;

FIG. 2 is a schematic view of print heads as seen from their ejection opening side;

FIG. 3A is a perspective view illustrating a schematic configuration of a printing apparatus;

FIG. 3B is a side view illustrating the schematic configuration of the printing apparatus;

FIG. 4 is a block diagram illustrating a configuration of a printing system;

FIGS. 5A and 5B are flowcharts illustrating processing executed in an image processing unit;

FIGS. 6A and 6B are diagrams illustrating mask patterns to be used in respective main scans;

FIG. 7 is a view illustrating a positional relationship between images α and β printed and to be printed by the print heads and a heating apparatus;

FIG. 8 is an explanatory diagram illustrating a printing operation in a multipass printing mode;

FIGS. 9A and 9B are flowcharts illustrating processing executed in a second embodiment;

FIG. 10 is a diagram illustrating a state in which image unevenness has occurred in a wait mode;

FIG. 11 is a diagram illustrating a wait time given for each scan in a case of implementing the wait mode;

FIGS. 12A and 12B are flowcharts illustrating processing executed in a third embodiment;

FIG. 13 is a flowchart illustrating processing executed in a printing operation in FIG. 12A;

FIG. 14 is a schematic perspective view illustrating a full line-type printing apparatus;

FIGS. 15A to 15D are schematic cross-sectional views illustrating how an ink droplet forms a film on a non-permeable print medium; and

FIGS. 16A and 16B are diagrams schematically illustrating a part of binary image data.

### DESCRIPTION OF THE EMBODIMENTS

Printing apparatuses and printing methods in embodiments of the present disclosure will be described below with reference to the drawings. The following description will be given by taking printing apparatuses using an inkjet printing method as an example. Here, the printing apparatuses using an inkjet printing method may each be, for example, a single-function printer having only a printing function or a multi-function printer having a plurality of functions such as a printing function, a fax function, and a scanner function. Alternatively, the printing apparatuses may each be, for example, a component of a manufacturing apparatus for manufacturing a color filter, an electronic device, an optical device, a microscopic structure, or the like by an inkjet printing method.

Note that in the following description, “printing” not only includes formation of information with a meaning, such as letters and a figure, but also formation of a figure with no meaning. Further, “printing” also includes formation of a variety of things such as an image, a design, a pattern, a structure, and so on onto a print medium regardless of whether they are elicited so as to be visually perceivable by humans.

Also, “print medium” is not limited to paper or the like generally used in printing apparatuses, but also includes things that can receive inks such as cloth, plastic film, sheet metal, glass, ceramic, resin, wood, and leather. In particular, “non-permeable print medium” refers to a print medium with no ink permeability for aqueous inks. In addition, “low-permeability medium” means a print medium with a lower ink permeability for aqueous inks than paper and the like generally used. More quantitatively, “low-permeability medium” refers to a print medium with such a printing surface that the amount of water absorbed in 30 msec^{1/2} after start of contact is 10 mL/m² or less in the Bristow method. This Bristow method is the most popular method to quickly measure the amount of liquid absorption, and even employed by the Japan Technical Association of the Pulp and Paper Industry (JAPAN TAPPI).

Details of the test method are described in Standard No. 51 “Paper and Paperboard—Liquid Absorption Test Method—Bristow Method” in “JAPAN TAPPI PAPER AND PULP TEST METHODS 2000 Version”.

Examples of the non-permeable print medium include those that are not produced as print media for aqueous inkjet inks, such as glass, plastic, film, and Yupo. Examples also include those without a surface treatment for inkjet printing (those without an ink absorption layer formed thereon), such as plastic films and substrates such as paper coated with plastic. Examples of the plastic include polyvinyl chloride, polyethylene terephthalate, polycarbonate, polystyrene, polyurethane, polyethylene, polypropylene, and so on. In addition, examples of the low-permeability print medium include print media such as printed book papers to be used in offset printing, etc., such as art paper and coated paper, and so on.

Further, “ink” should be interpreted broadly, as with the above-mentioned definition of “printing”. Thus, “ink” refers to a liquid that is applied onto a print medium for formation of an image, a design, a pattern, or the like, processing of the print medium, or processing of the ink (e.g., solidification or insolubilization of the coloring material in the ink applied onto the print medium).

Also, “ink having a property that improves an image” refers to an ink for improving image performance such as image fastness and appearance quality. Here, “improving image fastness” refers to improving at least one of scratch resistance, weather resistance, water resistance, or alkali resistance to improve the fastness of an ink image. On the other hand, “improving image appearance quality” means improving at least one of glossiness, a haze characteristic, or a bronze characteristic to improve the appearance quality of an ink image.

Here, “scratch resistance” is a property evaluated by using a minimum load value measured by following the method specified in Japanese Industrial Standard, K—Chemical engineering, Testing methods for paints Part 5: Mechanical property of film—Section 5: Scratch hardness (Stylus method) (JIS K 5600-5-5) (Apr. 20, 1999). Further, “improving the scratch resistance” means “raising the minimum load value”.

Also, “weather resistance” is a property evaluated by using a degree (grade) of change measured by following a method specified in Japanese Industrial Standard, K—Chemical engineering, Testing Methods for Paints—Part 7: Long-Period Performance of Film—Section 1: Resistance to Neutral Spray (JIS K 5600-7) (Feb. 20, 2008). For example, the degree of change in color is evaluated by using the color difference or the like. Further, “improving the weather resistance” means “lowering the value of the degree (grade) of change”.

Also, “water resistance” and “alkali resistance” are properties evaluated by observing a sign of damage measured by following a method specified in Japanese Industrial Standard, K—Chemical engineering, Testing methods for paints—Part 6: Chemical property of film—Section 1: Resistance to liquids (General methods) (JIS K 5600-6-1) (Mar. 22, 2016). Further, “improving the water resistance” means “reducing the sign of damage”.

Also, “glossiness” is a property evaluated by using a degree of glossiness measured by following the method specified in Japanese Industrial Standard, K—Chemical engineering, Testing methods for paints—Part 4: Visual characteristics of film—Section 7: Specular gloss (JIS K 5600-4-7) (Apr. 20, 1999). Further, “improving the glossiness” means “raising the value of the degree of glossiness”.

Also, “haze characteristic” is a property evaluated by using a haze value measured by following a method specified in Japanese Industrial Standard, K—Chemical engineering, Plastics—Determination of image clarity (JIS K 7374) (Nov. 20, 2007). Further, “improving the haze characteristic” means “lowering the haze value”.

Also, “bronze characteristic” is a property evaluated by using chromaticity measured by following a method specified in Japanese Industrial Standard, K—Chemical engineering, General Rules for Molecular Absorptiometric Analysis (JIS K 0115) (Mar. 20, 2004). Further, “improving the bronze characteristic” means “shifting the value of the chromaticity toward the achromatic side”.

### First Embodiment

A first embodiment of the present disclosure will be described below.

### (Configuration of Apparatus)

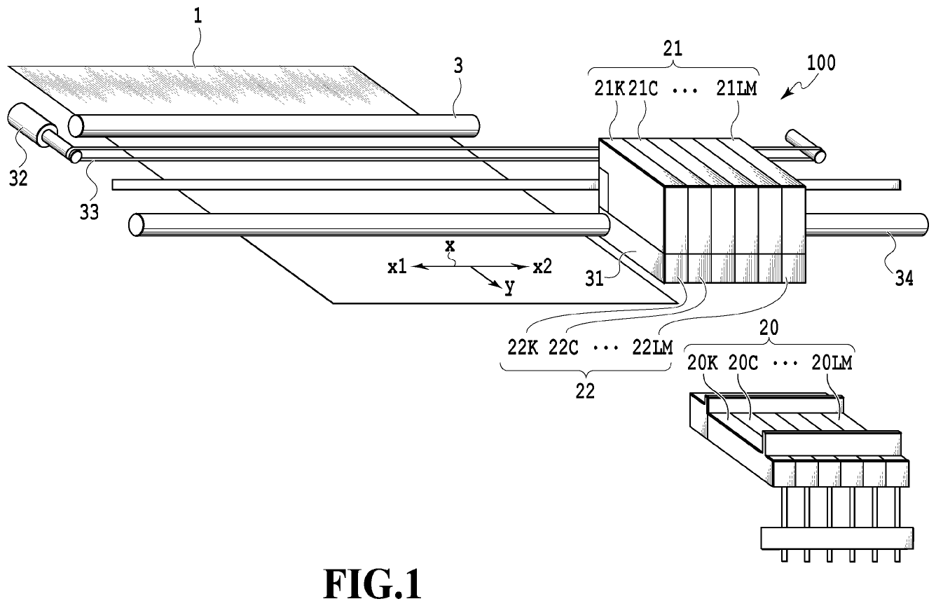

A printing apparatus in this embodiment is a so-called serial-type printing apparatus that prints an image onto a print medium by ejecting inks from ejection openings in print heads while moving the print heads in a predetermined main scanning direction. Specifically, it has the configuration illustrated in FIG. 1.

FIG. 1 is a perspective view illustrating a configuration of a main part of a printing apparatus 100 employing an inkjet printing method in this embodiment.

Print heads 22 include six print heads 22K, 22C, 22M, 22Y, 22LC, and 22LM that eject black (K), cyan C, magenta (M), yellow (Y), light cyan (LC), and light magenta (LM) inks, respectively. The print heads 22 are mounted on a carriage 31 provided so as to be reciprocally movable in the main scanning direction (the x direction in FIG. 1) along a guide shaft 34 extending in the main scanning direction. The carriage 31 is fixed to an endless belt 33 that moves in a loop by using a carriage motor 32. The endless belt 33 moves with forward and reverse rotations of the carriage motor 32, and the carriage 31 moves along with the endless belt 33 in a forward direction (x1 direction) and a backward direction (x2 direction).

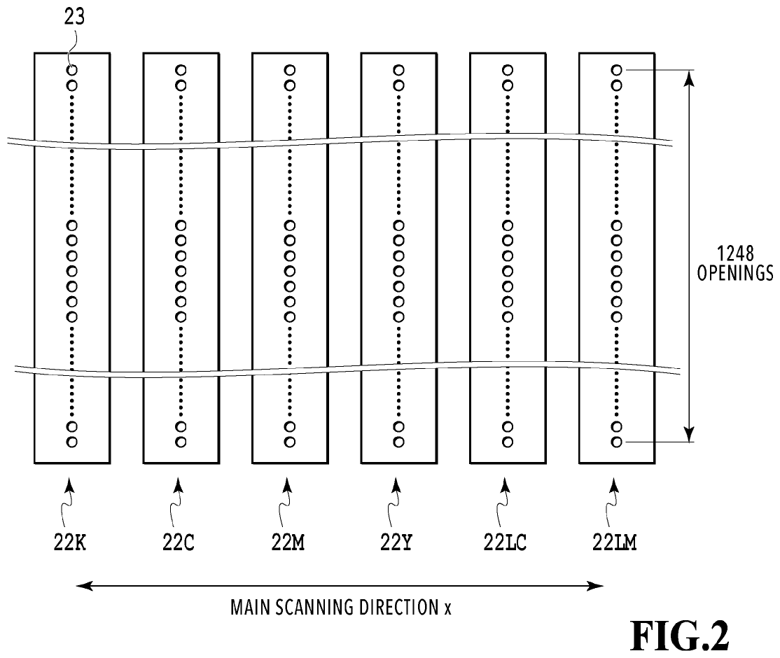

In each of the print heads 22K, 22C, 22M, 22Y, 22LC, and 22LM, 1248 ejection openings are arranged at a density of 1200 dpi along a direction (sub-scanning direction: y direction) orthogonal to the main scanning direction (x direction), and these form an ejection opening array. In each ejection opening is provided an ejection energy generation element (not illustrated) that generates ejection energy for ink ejection. An electrothermal conversion element (heater), an electromechanical conversion element (piezoelectric element), or the like can be used as the ejection energy generation element. In this example, the amount of the ink ejected from each ejection opening in a single ejection is approximately 4.5 ng. An image is printed onto a print medium 1 by ejecting the inks from these ejection openings based on print data. Note that FIG. 2 is a view of the print heads 22 as seen from the ejection opening side.

Also, to the print heads 22K, 22C, 22M, 22Y, 22LC, and 22LM are connected ink tanks 21 for supplying the inks to the respective print heads 22. The ink tanks 21 include six ink tanks 21K, 21C, 21M, 21Y, 21LC, and 21LM storing the respective inks. These ink tanks 21 are also supported on the carriage 31, and reciprocally move along with the print heads 22 in the main scanning direction (x direction).

Also, caps 20 capable of covering the ejection openings of the print heads 22 mounted on the carriage 31 are provided at a home position being a reference position in the main scanning direction for the carriage 31. The caps 20 include six caps 20K, 20C, 20M, 20Y, 20LC, and 20LM in order to cap the ejection opening surfaces of the six print heads (the surfaces in which their ejection openings are formed). In a case where printing is not performed, the print heads 22 and the ink tanks 21 return to and wait at the home position, at which the caps 20 are provided. Then, in a case where the wait of the print heads 22 at the home position reaches a certain amount of time, the ejection opening surfaces of the print heads 22 are covered (capped) by the caps 20 in order to prevent the ejection openings of the print heads 22 from drying.

Note that in a case where these print heads, ink tanks, and caps are individually mentioned, the individual reference signs given to them will be used and, in a case where the print heads, the ink tanks, and the caps are mentioned collectively, “22”, “21”, and “20” will be used as collective reference signs for the print heads, the ink tanks, and the caps, respectively.

Meanwhile, the print heads 22 and the ink tanks 21 used here may be configured such that the print heads 22 and the ink tanks 21 are integrated with each other or separable from each other.

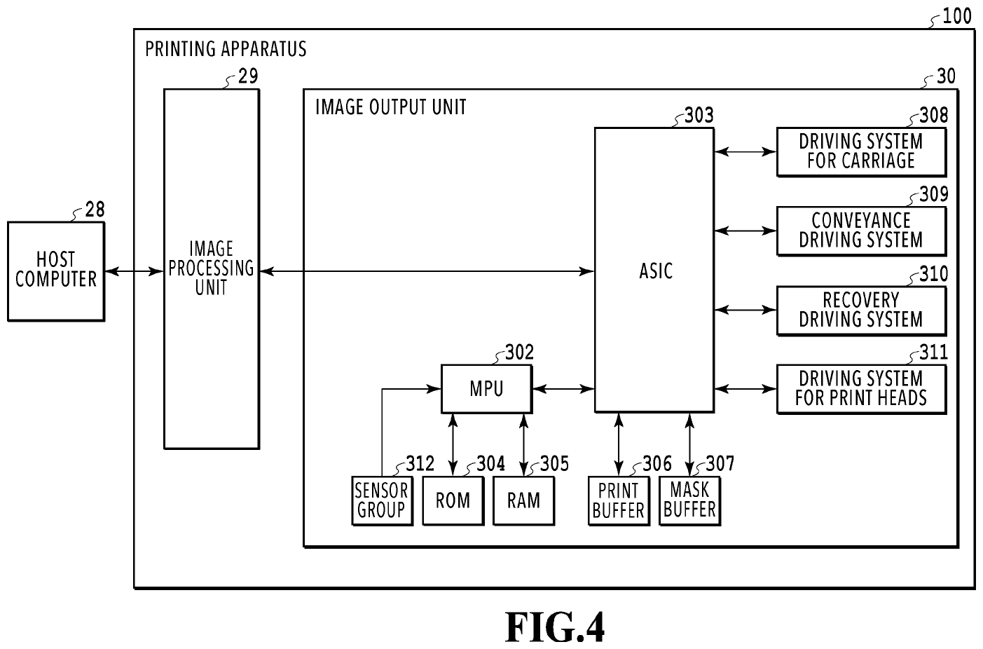

The printing apparatus 100 is further provided with a conveyance unit that conveys the print medium 1 in a direction crossing the main scanning direction (x direction) (in this embodiment, a direction orthogonal to the main scanning direction) in synchronization with a main scan of the carriage 31. Hereinafter, this direction orthogonal to the main scanning direction will be referred to as the sub-scanning direction (or the conveyance direction). In the example illustrated in FIG. 1, the conveyance unit includes a conveyance roller 3 that rotates about a rotational center axis extending in the main scanning direction, and a conveyance motor not illustrated that rotates the conveyance roller 3. The conveyance roller 3 intermittently rotates in contact with the print medium 1 by using the conveyance motor to intermittently convey the print medium 1 by a predetermined amount at a time. By repeating this operation of conveying the print medium 1 and a main scan of the print heads 22, an image is printed onto the print medium 1. Note that the conveyance speed of the print medium 1, the main scan speed and ejection operation rate (driving frequency) of the print heads 22, and the like are controlled by an image output unit 30 (FIG. 4) serving as a later-described control unit.

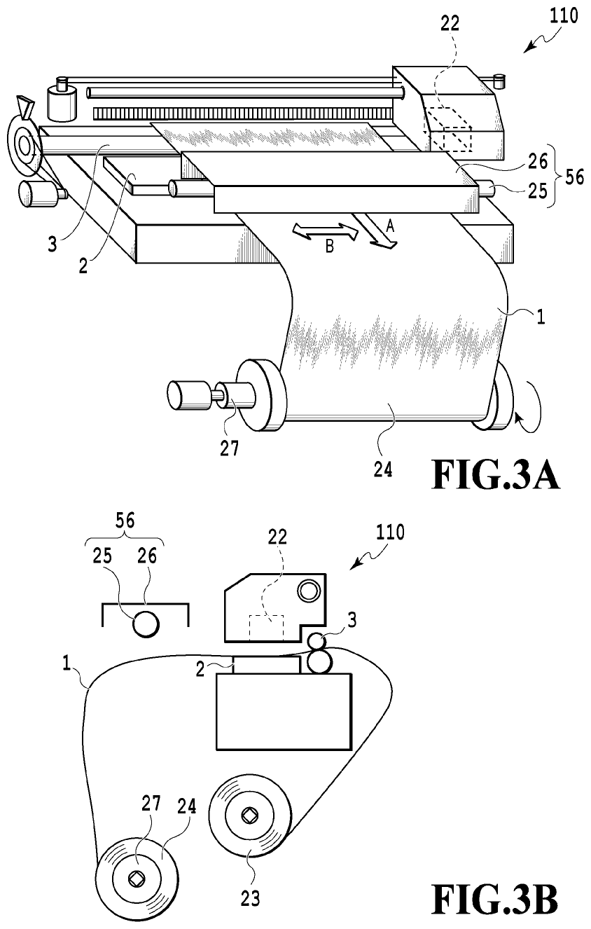

FIGS. 3A and 3B are views illustrating a schematic configuration of another printing apparatus 110 in this embodiment, FIG. 3A being a perspective view and FIG. 3B being a side view.

A heater 25 supported on a frame not illustrated is disposed at a position downstream in the sub-scanning direction of a position where the print heads 22 are reciprocally scanned in the main scanning direction (x direction). Heat of this heater 25 is used to dry liquid inks ejected onto a print medium 1. The heater 25 is covered with a heater cover 26. The heater cover 26 has a function of efficiently applying the heat of the heater 25 onto the print medium 1 and a function of protecting the heater 25. The heater 25 and the heater cover 26 form a heating unit 56. Note that the printing apparatus 110 illustrated here is a printing apparatus that uses a roll sheet 23 being a print medium 1 rolled up into a roll. The print medium 1 fed out of the roll sheet 23 is printed by the print heads 22 and then wound around a winding spool 27, thereby forming a roll-shaped wound medium 24. Note that specific examples of the heater 25 include a sheathed heater, a halogen heater, and the like.

### (Compositions of Inks)

Next, the inks used in this embodiment will be described. In the following, “part” and “%” are based on mass, unless otherwise noted.

### <Black Ink>

### (1) Preparation of Pigment Dispersion Liquid

Firstly, an anionic macromolecule P-1 (styrene/butyl acrylate/acrylic acid copolymer (polymerization ratio (weight ratio)=30/40/30), acid value=202, weight average molecular weight=6500) is prepared. This is neutralized with a potassium hydroxide aqueous solution and diluted with ion-exchanged water to prepare a homogeneous 10-mass % polymer aqueous solution.

100 g of the above polymer aqueous solution, 100 g of carbon black, and 300 g of ion-exchanged water are blended and mechanically agitated for 0.5 hour. Then, using a micro-fluidizer, this mixture is processed by passing it through an interaction chamber five times under a liquid pressure of approximately 70 MPa. Further, the dispersion liquid obtained in the above is subjected to a centrifugation process (12,000 rpm, 20 minutes) to remove non-dispersive substances including coarse particles, so that a black dispersion liquid is obtained. The black dispersion liquid obtained has a pigment concentration of 10 mass %, and a dispersant concentration of 6 mass %.

### (2) Preparation of Fine Resin Particle Dispersion Liquid

First, under a nitrogen atmosphere, the following three additive liquids heated to 70° C. are added to each other by dripping them little by little while agitating them by using a motor, and polymerized for five hours. The additive liquids are a hydrophobic monomer having 28.5 parts of methyl methacrylate, a mixture liquid containing a hydrophilic monomer having 4.3 parts of sodium p-styrenesulfonate and 30 parts of water, and a mixture liquid containing a polymerization initiator having 0.05 part of potassium persulfate and 30 parts of water.

### (3) Preparation of Ink

An ink is prepared by using the above black dispersion liquid and the above fine resin particle dispersion liquid. The following components are added to these at a predetermined concentration, and these components are sufficiently blended and agitated and then filtered under pressure through a micro-filter with a pore size of 2.5 μm (manufactured by FUJIFILM Corporation) to prepare a pigment ink having a pigment concentration of 5 mass % and a dispersant concentration of 3 mass %.

| | |
|---|---|
| The above black dispersion liquid | 50 parts |
| The above fine resin particle dispersion liquid | 10 parts |
| Zonyl FSO-100 (a fluorine-based surfactant | 0.05 parts |
| manufactured by DuPont) | |
| 2-methyl 1,3 propanediol | 15 parts |
| 2-pyrrolidone | 5 parts |
| Acetylene glycol EO adduct | 0.5 parts |
| Ion-exchanged water (manufactured by | Balance |
| Kawaken Fine Chemicals Co., Ltd.) | |

### <Cyan Ink>

### (1) Preparation of Dispersion Liquid

First, using benzyl acrylate and methacrylic acid as raw materials, an AB block polymer having an acid value of 250 and a number average molecular weight of 3000 is produced in a usual or customary manner, and further is neutralized with a potassium hydroxide aqueous solution and diluted with ion-exchanged water to prepare a homogeneous 50-mass % polymer aqueous solution.

180 g of the above polymer solution, 100 g of C.1.Pigment Blue 15:3, and 220 g of ion-exchanged water are blended and mechanically agitated for 0.5 hour.

Then, using a micro-fluidizer, this mixture is processed by passing it through an interaction chamber five times under a liquid pressure of approximately 70 MPa.

Further, the dispersion liquid obtained in the above is subjected to a centrifugation process (12,000 rpm, 20 minutes) to remove non-dispersive substances including coarse particles, so that a cyan dispersion liquid is obtained. The cyan dispersion liquid obtained has a pigment concentration of 10 mass %, and a dispersant concentration of 10 mass %.

### (2) Preparation of Fine Resin Particle Dispersion Liquid

A fine resin particle dispersion liquid is prepared using materials and a preparation method similar to those described for the black ink.

### (3) Preparation of Ink

An ink is prepared by using the above cyan dispersion liquid and the above fine resin particle dispersion liquid. The following components are added to these at a predetermined concentration. Further, these components are sufficiently blended and agitated and then filtered under pressure through a micro-filter with a pore size of 2.5 μm (manufactured by FUJIFILM Corporation) to prepare a pigment ink having a pigment concentration of 2 mass % and a dispersant concentration of 2 mass %.

| | |
|---|---|
| The above cyan dispersion liquid | 20 parts |
| The above fine resin particle dispersion liquid | 10 parts |
| Zonyl FSO-100 (a fluorine-based surfactant | 0.05 parts |
| manufactured by DuPont) | |
| 2-methyl 1,3 propanediol | 15 parts |
| 2-pyrrolidone | 5 parts |
| Acetylene glycol EO adduct | 0.5 parts |
| Ion-exchanged water (manufactured by | Balance |
| Kawaken Fine Chemicals Co., Ltd.) | |

### <Magenta Ink>

### (1) Preparation of Dispersion Liquid

First, using benzyl acrylate and methacrylic acid as raw materials, an AB block polymer having an acid value of 300 and a number average molecular weight of 2500 is produced in a usual or customary manner, and further is neutralized with a potassium hydroxide aqueous solution and diluted with ion-exchanged water to prepare a homogeneous 50-mass % polymer aqueous solution.

100 g of the above polymer solution, 100 g of C.1.Pigment Red 122, and 300 g of ion-exchanged water are blended and mechanically agitated for 0.5 hour.

Then, using a micro-fluidizer, this mixture is processed by passing it through an interaction chamber five times under a liquid pressure of approximately 70 MPa.

Further, the dispersion liquid obtained in the above is subjected to a centrifugation process (12,000 rpm, 20 minutes) to remove non-dispersive substances including coarse particles, so that a magenta dispersion liquid is obtained. The magenta dispersion liquid obtained has a pigment concentration of 10 mass %, and a dispersant concentration of 5 mass %.

### (2) Preparation of Fine Resin Particle Dispersion Liquid

A fine resin particle dispersion liquid is prepared using materials and a preparation method similar to those described for the black ink.

### (3) Preparation of Ink

An ink is prepared by using the above magenta dispersion liquid and the above fine resin particle dispersion liquid. The following components are added to these at a predetermined concentration. Further, these components are sufficiently blended and agitated and then filtered under pressure through a micro-filter with a pore size of 2.5 μm (manufactured by FUJIFILM Corporation) to prepare a pigment ink having a pigment concentration of 4 mass % and a dispersant concentration of 2 mass %.

| | |
|---|---|
| The above magenta dispersion liquid | 40 parts |
| The above fine resin particle dispersion liquid | 10 parts |
| Zonyl FSO-100 (a fluorine-based surfactant | 0.05 parts |
| manufactured by DuPont) | |
| 2-methyl 1,3 propanediol | 15 parts |
| 2-pyrrolidone | 5 parts |
| Acetylene glycol EO adduct | 0.5 parts |
| Ion-exchanged water (manufactured by | Balance |
| Kawaken Fine Chemicals Co., Ltd.) | |

### <Yellow Ink>

### (1) Preparation of Dispersion Liquid

First, the above anionic macromolecule P-1 is neutralized with a potassium hydroxide aqueous solution and diluted with ion-exchanged water to prepare a homogeneous 10-mass % polymer aqueous solution.

30 parts of the above polymer solution, 10 parts of C.1.Pigment Yellow 74, and 60 parts of ion-exchanged water are blended and introduced into a batch-type vertical sand mill (manufactured by IMEX Co., Ltd.), 150 parts of zirconia beads having a diameter of 0.3 mm are introduced, and the mixture is subjected to a dispersion process for 12 hours while being water-cooled.

Further, the dispersion liquid obtained in the above is subjected to a centrifugation process to remove non-dispersive substances including coarse particles, so that a yellow dispersion liquid is obtained. Approximately 12.5% of the yellow dispersion liquid obtained is solid contents, and the weight average particle size is 120 nm.

### (2) Preparation of Fine Resin Particle Dispersion Liquid

A fine resin particle dispersion liquid is prepared using materials and a preparation method similar to those described for the black ink.

### (3) Preparation of Ink

An ink is prepared by using the above yellow dispersion liquid and the above fine resin particle dispersion liquid. The following components are blended and sufficiently agitated to be dissolved and dispersed, and then filtered under pressure through a micro-filter with a pore size of 1.0 μm (manufactured by FUJIFILM Corporation) to prepare the ink.

| | |
|---|---|
| The above yellow dispersion liquid | 40 parts |
| The above fine resin particle dispersion liquid | 10 parts |
| Zonyl FSO-100 (a fluorine-based surfactant | 0.05 parts |
| manufactured by DuPont) | |
| 2-methyl 1,3 propanediol | 15 parts |
| 2-pyrrolidone | 5 parts |
| Acetylene glycol EO adduct | 0.5 parts |
| Ion-exchanged water (manufactured by Kawaken | Balance |
| Fine Chemicals Co., Ltd.) | |

### <Light Cyan Ink>

### (1) Preparation of Dispersion Liquid

A cyan dispersion liquid having a pigment concentration of 10 mass % is prepared using materials and a preparation method similar to those described for the cyan ink.

### (2) Preparation of Fine Resin Particle Dispersion Liquid

A fine resin particle dispersion liquid is prepared using materials and a preparation method similar to those described for the black ink.

### (3) Preparation of Ink

An ink is prepared by using the above cyan dispersion liquid and the above fine resin particle dispersion liquid. The following components are added to these at a predetermined concentration. Further, these components are sufficiently blended and agitated and then filtered under pressure through a micro-filter with a pore size of 2.5 μm (manufactured by FUJIFILM Corporation) to prepare the ink.

| | |
|---|---|
| The above cyan dispersion liquid | 4 parts |
| The above fine resin particle dispersion liquid | 10 parts |
| Zonyl FSO-100 (a fluorine-based surfactant | 0.05 parts |
| manufactured by DuPont) | |
| 2-methyl 1,3 propanediol | 15 parts |
| 2-pyrrolidone | 5 parts |
| Acetylene glycol EO adduct | 0.5 parts |
| Ion-exchanged water (manufactured by | Balance |
| Kawaken Fine Chemicals Co., Ltd.) | |

### <Light Magenta Ink>

### (1) Preparation of Dispersion Liquid

A magenta dispersion liquid having a pigment concentration of 10 mass % is prepared using materials and a preparation method similar to those described for the magenta ink.

### (2) Preparation of Ink

An ink is prepared by using the above magenta dispersion liquid and the above fine resin particle dispersion liquid. The following components are added to these at a predetermined concentration. Further, these components are sufficiently blended and agitated and then filtered under pressure through a micro-filter with a pore size of 2.5 μm (manufactured by FUJIFILM Corporation) to prepare the ink.

| | |
|---|---|
| The above magenta dispersion liquid | 4 parts |
| The above fine resin particle dispersion liquid | 10 parts |
| Zonyl FSO-100 (a fluorine-based surfactant | 0.05 parts |
| manufactured by DuPont) | |
| 2-methyl 1,3 propanediol | 15 parts |
| 2-pyrrolidone | 5 parts |
| Acetylene glycol EO adduct | 0.5 parts |
| Ion-exchanged water (manufactured by | Balance |
| Kawaken Fine Chemicals Co., Ltd.) | |

The inks used in this embodiment are characterized in that they contain “fine resin particles” in order to be fixed onto a non-permeable print medium. “Fine resin particles” mean fine particles made of a resin and having such a particle size as to be dispersible in an aqueous medium. The fine resin particles have a function of fixing the pigment onto a surface of a print medium by being heated to be melted and form a film (film formation) on the surface of the print medium.

In this embodiment, a glass transition point Tg of the resin making up the fine resin particles is preferably higher than 30° C. and lower than 80° C. If the glass transition point Tg of the resin is 30° C. or lower, the difference between the glass transition point Tg and room temperature will be small and the fine resin particles will be in a nearly melted state within the ink. This raises the viscosity of the ink inside the print head 22 and may lower image appearance quality (such as coloration and sharpness) due to defective ink ejection.

If the glass transition point Tg of the resin is 80° C. or higher, a large amount of heat will be needed at the heating unit to melt the fine resin particles. This may lead to a failure to melt the fine resin particles before the pigment agglutinates with evaporation of the water in the ink, and lower image appearance quality (such as coloration).

The resin making up the fine resin particles is not particularly limited as long as its glass transition point Tg is within the above range. Specifically, examples include an acrylic resin, a styrene-acrylic resin, a polyethylene resin, a polypropylene resin, a polyurethane resin, a styrene-butadiene resin, a fluoroolefin-based resin, and so on. For example, the acrylic resin can be obtained by combining monomers of a (meth)acrylic acid alkyl ester, a (meth)acrylic acid alkyl amide, or the like via emulsion polymerization or the like. In addition, the styrene-acrylic resin can be obtained by combining monomers of a (meth)acrylic acid alkyl ester, a (meth)acrylic acid alkyl amide, or the like and styrene via emulsion polymerization or the like. By the emulsion polymerization, an emulsion with fine particles of the above resin (fine resin particles) dispersed in a medium can be obtained.

In the present disclosure, fine resin particles made of any generally used resin component that is insoluble in water can also be used as fine resin particles having a sulfonic acid group.

The resin component making up the fine resin particles is not particularly limited as long as it is a resin containing a sulfonic acid group, and any resin component such as any natural or synthetic macromolecule generally used or a macromolecule newly developed for this embodiment can be used without a limitation. In particular, a polymer or copolymer of monomer components with a radically polymerizable unsaturated bond, by which acrylic resins and styrene/acrylic resins are classified, can be used in view of availability for general use and convenience in designing the functionality of the fine resin particles.

Generally, a surfactant is used as a penetrant to improve the permeability of ink into a print medium dedicated for inkjet printing. In the case of a non-permeable print medium, it is used to improve the wettability. The larger the amount of the surfactant added, the stronger a property of lowering the surface tension of the ink, and the more the wettability and permeability of the ink on and into a print medium are improved. As the surfactant, it is preferable to use an acetylene glycol EO adduct or a fluorine- or silicone-based surfactant. The fluorine- or silicone-based surfactant, even if its content is small, can lower the surface tension of the ink and therefore enhance the wettability of the ink on a print medium. Thus, even in a case of performing printing on a non-water absorbing print medium, repelling of the ink on the surface of the print medium is suppressed. Accordingly, image quality can be improved further. In this embodiment, the surface tension of each ink is uniformly set at 30 dyn/cm or lower as a preferred surface tension.

The surface tension is measured using a fully-automatic surface tensiometer CBVP-Z (manufactured by Kyowa Interface Science Co., Ltd.). Note that the measurement apparatus is not limited to the one exemplarily mentioned above as long as the surface tension of each ink can be measured.

Meanwhile, each ink in this embodiment uses an anionic color material, so that the pH of the ink is stable on the alkali side and the value is 8.5 to 9.5. Generally, the pH of the ink is preferably 7.0 or greater and 10.0 or less in view of preventing elution of impurities from members that contact the ink, deterioration of the materials making up the members, lowering of the solubility of the pigment dispersion resin in the ink, and so on. The pH is measured using a pH meter F-52 manufactured by HORIBA, Ltd. Note that the measurement apparatus is not limited to the one exemplarily mentioned above as long as the pH of each ink can be measured.

(Characteristic Configuration of this Embodiment)

A polyvinyl chloride sheet (PVC sheet) being the above-mentioned non-permeable print medium is a flexible sheet manufactured from a polyvinyl chloride resin as a main raw material with a plasticizer added therein. This PVC sheet has good printability for gravure printing, screen printing, and the like and embossability (ease of forming a recessed and/or raised design by pressing a mold). Since the combination of these allow a greater variety of expressions, the PVC sheet has been used in many products such as tarpaulin, canvas, and wallpaper. Since a polyvinyl chloride resin is the main raw material, the PVC sheet has no aqueous ink permeability at all. In this embodiment, a white glossy PVC sheet with adhesive (gray glue) (manufactured by KIMOTO Co., Ltd., thickness=100 μm) is used as a print medium with no aqueous ink permeability. This PVC sheet is to be subjected to printing using inks containing fine resin particles that melt with heat, followed by film formation and solvent drying with a heater.

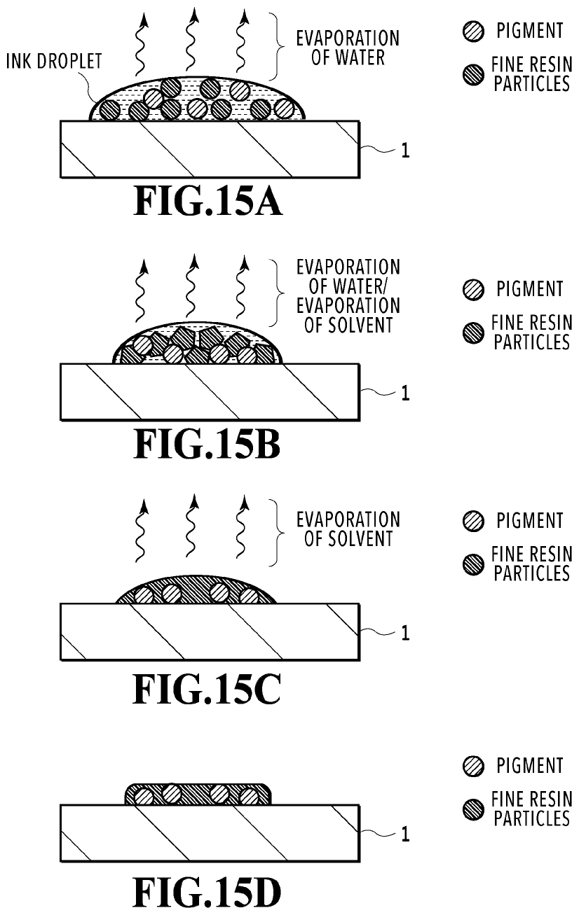

In the printing method in this embodiment, as schematically illustrated in FIGS. 15A to 15D, fine resin particles on a non-permeable print medium 1 with an ink applied to the non-permeable print medium 1 are heated by a heating unit or the like to melt the fine resin particles and also evaporate the solvent in the ink. This allows the pigment to be fixed to the print medium 1.

The heating temperature for fixing the pigment to the print medium 1 is desirably the minimum film formation temperature of the fine resin particles or higher. In addition, it is necessary to evaporate most of the liquid component, such as the solvent, in the ink during the heating. Thus, the configuration in this embodiment is such that a temperature distribution is provided in the conveyance direction of the print medium 1 to ensure a heating time for supplying energy required to evaporate most of the liquid component.

Note that the “minimum film formation temperature (MFT)” in this embodiment means the minimum temperature required by the fine resin particles to melt via heating and form a resin film (film formation). This MFT can be easily measured using a minimum film formation temperature measurement apparatus. With this minimum film formation temperature measurement apparatus, an ink containing fine resin particles (containing at least a pigment, water, a water-soluble solvent, or the fine resin particles) is spread over a highly thermally conductive metal plate with a temperature gradient, and the temperature of a spot where a dry film is formed is measured as the minimum film formation temperature.

The printing method in this embodiment includes a step of heating at least a surface of a non-permeable print medium onto which an ink has been applied. In particular, the printing method includes a step of heating a portion of the non-permeable print medium downstream in the sub-scanning direction (print medium conveyance direction (y direction)) of a region to which an ink has been applied.

Generally, the heating temperature to be applied to each ink by the heating unit 56 is preferably 50° C. to 120° C. Depending on the general types and amounts of the fine resin particles and solvent contained the ink, a large amount of the solvent contained in the ink may remain in the ink film even after passing the heating unit if the temperature is low, in particular, lower than 50° C. On the other hand, if the heating temperature is high, in particular, 120° C. or higher, the print medium 1, such as a PVC sheet or film, may be subjected to such medium damages that the entire print medium 1 gets stretched or shrunk by the heat or the print medium 1 gets partially stretched or shrunk and becomes wavy. For this reason, in this embodiment, an image is printed by multipass printing (6-pass printing mode) in which the image is completed with six scans. The heating temperature on the PVC sheet during this printing is set at 100° C. in consideration of the ink film formability and productivity.

### (Configuration of Control System in Printing System)

FIG. 4 is a block diagram illustrating a configuration of a control system in the printing apparatus 100 used in this embodiment. A host computer (image input unit) 28 transmits multivalued image data in an RGB format stored in any of various storage media, such as a hard disk drive, to an image processing unit 29. The image processing unit 29 is capable of also obtaining the multivalued image data from an image input instrument, such as a scanner or a digital camera, connected to the host computer 28. The image processing unit 29 performs later-described image processing on the obtained multivalued image data to convert it into binary image data. As a result, binary image data for ejecting a plurality of types of pigment inks from the respective print heads 22 (ink ejection data) is generated.

Based on the binary image data generated by the image processing unit 29, which correspond to at least two types of pigment inks, the image output unit 30 of the printing apparatus 100 applies the pigment inks onto the print medium 1 to print an image. The image output unit 30 is controlled by a microprocessor unit (MPU) 302 in accordance with a program stored in a ROM 304.

A RAM 305 is utilized as a work area and a storage area for temporarily storing data for the MPU 302. The MPU 302 functions as a control unit that comprehensively controls a driving system 308 for the carriage 31, a conveyance driving system 309 for the print medium, a recovery driving system 310 for the print heads 22, and a driving system 311 for the print heads via an ASIC 303. Here, the driving system for the carriage 31 includes the motor 32 as a driving source for moving the carriage 31 in the main scanning direction, a driving circuit for the motor 32, and so on. In addition, the conveyance driving system 309 for the print medium includes a conveyance motor as a driving source for rotating the conveyance roller 3, a driving circuit for this conveyance motor, and so on. The driving system 311 for the print heads includes a driving circuit for the ejection energy generation elements provided in the ejection openings of the print heads. Also, the recovery driving system 310 includes a cap raising-lowering mechanism that raises and lowers the caps 20 to cover and open the ejection opening surfaces of the print heads 22, a driving motor for the mechanism, and so on.

Also connected to the MPU 302 are a sensor group 312 that detect the operations and positions of components during the control of the driving systems. One of the sensors included in this sensor group is, for example, a carriage sensor that detects the position of the carriage 31 in the main scanning direction. The carriage sensor is configured as a linear encoder that detects the position of the carriage 31, a rotary encoder that detects the rotational amount of the carriage motor 32, or the like. The sensor group 312 also includes a conveyance system sensor that detects an operation of conveying the print medium 1 by the conveyance roller 3 and the position of the conveyed print medium 1, and so on. The conveyance system sensor includes a conveyance sensor that detects the amount of conveyance of the print medium 1 by the conveyance roller 3, an end sensor that detects the position of an end of the print medium or the like, and so on. As the conveyance sensor, for example, a rotary encoder that detects the rotational amount of the conveyance motor not illustrated can be employed.

The MPU 302 is capable of reading and writing image data to a print buffer 306 via the ASIC 303. The print buffer 306 temporarily holds image data converted into such a format as to be transferable to the print heads 22. A mask buffer 307 temporarily holds mask patterns read out of the ROM 304. Specifically, the ROM 304 stores a plurality of sets of mask patterns corresponding respectively to a plurality of different types of multipass printing to be described later. Then, the one set of mask patterns corresponding to predetermined multipass printing to be executed is read out of the ROM 304 and temporarily held in the mask buffer 307. Then, in a case of executing the predetermined multipass printing, the ASIC 303 performs AND processing on the mask patterns read out of the mask buffer 307 and the image data read out of the print buffer 306. As a result, pieces of image data corresponding to the respective main scans in the multipass printing to be executed are generated, and the pieces of generated image data are transferred to the print heads 22.

Although an example in which the image processing unit 29 is provided in the printing apparatus 100 has been shown in this embodiment, it is possible to employ a configuration in which the image processing unit 29 is provided in the host computer 28.

### (Printing Method)

Next, a printing method in which characteristic control of this embodiment is performed will be described. Meanwhile, in the following description, an ink application ratio at which a single dot is formed in a pixel being a unit region on the print medium 1 ( 1/1200 inch square (1200 dpi square)) will be referred to as a 100% duty. In addition, in this embodiment, a printing operation in which printing is performed by ejecting inks from the respective print heads 22 in each of forward and backward movements of the print heads 22 will be referred to as bidirectional printing.

Further, a printing mode in which the ejection opening array of each print head 22 is divided in the sub-scanning direction into a plurality of ejection opening groups and a main scan of such an ejection opening group is performed a plurality of times over a scan region having a width corresponding to the length of the ejection opening group to complete an image to be printed in this scan region will be referred to a multipass printing mode. A multipass printing mode in which a main scan is performed n times over a scan region to complete an image will be referred to as an n-pass printing mode. Specifically, a multipass printing mode in which an image in a main scan region is completed by performing six main scans will be referred to as the 6-pass printing mode, and a multipass printing mode in which an image in a main scan region is completed by performing eight main scans will be referred to as the 8-pass printing mode. Further, a multipass printing mode in which the above-mentioned bidirectional printing is performed will be referred to as a bidirectional multipass printing mode.

In this embodiment, “characteristic control” as below is performed in a bidirectional multipass printing mode. Specifically, control is performed in which the time for which a high-duty image portion where the ink application ratio is a predetermined value or greater passes through the above-mentioned heating unit 56 is made longer than the time for which a low-duty image portion where the ink application ratio is less than the predetermined value passes through the heating unit 56.

More specifically, while an image portion printed at a low duty passes through the heating unit 56, a bidirectional multipass printing mode is performed in which an image in a scan region is completed with six scans (hereinafter referred to as the 6-pass printing mode). On the other hand, while an image printed at a high duty passes through the heating unit 56, a multipass printing mode is performed in which an image is completed with eight main scans (hereinafter referred to as the 8-pass printing mode). In other words, the printing mode of a printing operation to be performed while an image portion completed by the print heads 22 passes through the heating unit 56 is changed to adjust the time for which the printed image portion passes through the heating unit 56. In this way, the time for which a region printed at a high duty, which has a possibility of experiencing a phenomenon such as “defective fixing (defective curing, defective scratch resistance)”, passes through the heating unit 56 can be made longer.

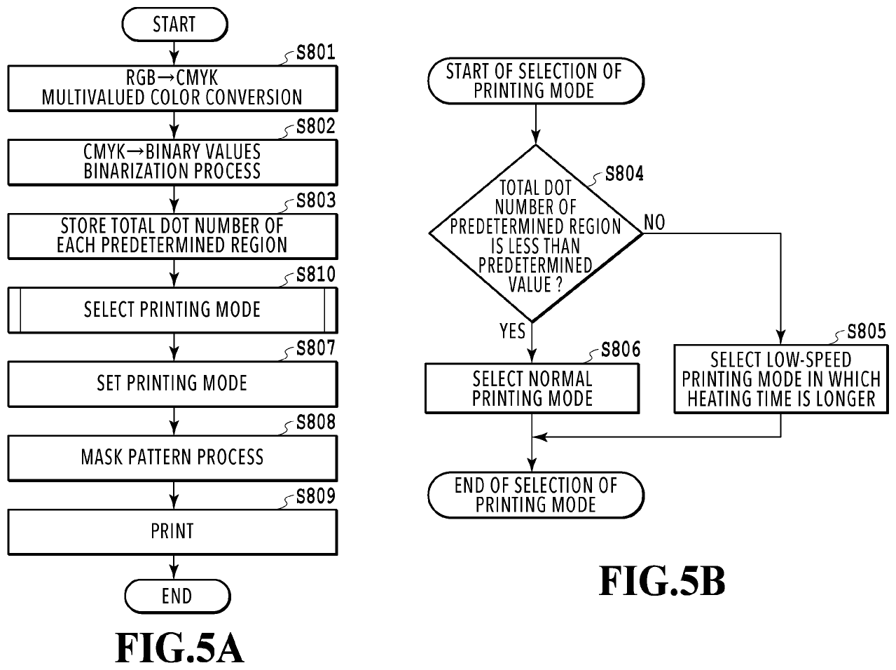

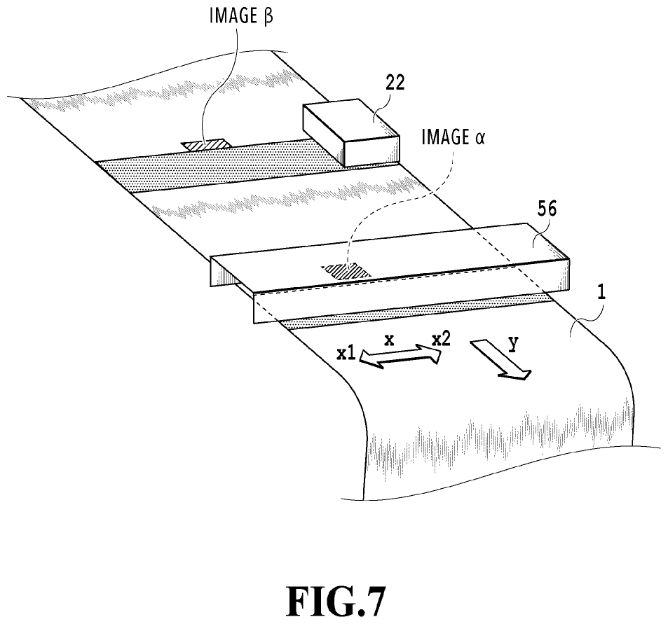

FIG. 5A is a flowchart illustrating processing executed by the image processing unit 29 and the image output unit 30. The symbol S attached to the step number of each process in the flowchart means a step. In this embodiment, binary image data (print data) is generated based on inputted multivalued image data, and a printing operation is performed based on this binary image data. Note that a description will be given here by taking as an example a printing operation for a subsequent image β which, as illustrated in FIG. 7, is started at the timing at which a preceding image a after being printed enters the space immediately under the heater 26.

In response to receiving the multivalued image data of the subsequent image β in the RGB format from the host computer (image input unit) 28, a color conversion process (multivalued color conversion process) is performed on the received multivalued image data is performed in S801. Specifically, the received multivalued image data in the RGB format is converted into pieces of multivalued image data corresponding respectively to the plurality of types of inks (K, C, M, Y, LC, and LM). Then in S802, the pieces of multivalued image data corresponding respectively to the plurality of types of inks are rasterized into pieces of binary image data according to stored patterns. As a result, pieces of binary image data to be given to the print heads 22 (22K, 22C, 22M, 22Y, 22LC, and 22LM) are generated.

Then in S803, the number of dots to be formed with inks is counted for each predetermined region forming a part of the image β based on the pieces of binary image data generated in S802. In this embodiment, a matrix formed of 16 vertical pixels×32 horizontal pixels is set as the predetermined region, and the total number of dots to be formed with a plurality of types of inks (total dot number) is counted for each matrix. Then, the counted total dot number is stored in association with the corresponding matrix as ink application information. Note that the size of the above-mentioned predetermined region (matrix) is not limited to 16 vertical pixels×32 horizontal pixels, and a matrix size other than this can be used.

Then in S810, the printing mode for the image β is selected. This printing mode selection process will be described later with reference to FIG. 5B. In S807, the printing mode selected in S810 is set. Then in S808, a process using mask patterns for distributing the pieces of binary image data to the plurality of scans (mask pattern process) is executed. As a result, pieces of ejection data in such a format as to be transferable to the print heads 22 are generated. Based on these pieces of ejection data, the driving system 311 for the print heads drives the print heads 22 to print the image β onto the print medium 1 (S809).

Now, the above-mentioned selection process performed in S810 will be described with reference to the flowchart of FIG. 5B. The printing mode to be used in the printing of the image β is selected using the total dot numbers of predetermined regions (matrices) included in the image α. First in S804, at the timing at which predetermined regions (matrices) included in a predetermined image (e.g., image α) enter the heating unit 56 or at a timing before it, the total dot number of each of the plurality of predetermined regions lying side by side in the main scanning direction is read out and whether the largest value among the total dot numbers is less than a predetermined value is determined. Here, the processing proceeds to S806 if the largest value among the total dot numbers of the plurality of predetermined regions (matrices) included in the image a and lying side by side in the main scanning direction is less than the predetermined value (if the result of the determination in S804 is YES). In S806, a normal printing mode (first printing mode) is selected as the printing mode to be used in the printing operation for the image β which is to be started at the timing at which the image a enters the heating unit 56. On the other hand, if in S804 the largest value among the total dot numbers of the plurality of predetermined regions lying side by side in the main scanning direction is the predetermined value or greater (if the result of the determination in S804 is NO), the processing proceeds to S805. In S805, a low-speed printing mode (second printing mode) in which the heating time for the image a is longer is selected as the printing mode to be used in the printing operation for the image β. As described above, the processing illustrated in FIG. 5B is characterized in that the printing mode for the image β which is about to start being printed at the timing at which the image a enters the heating unit 56 is selected.

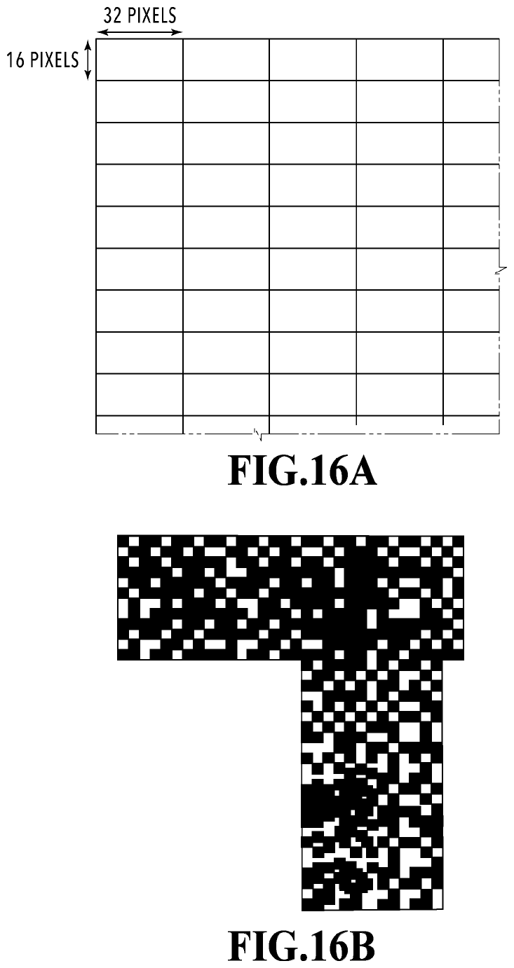

The processing performed in the flowcharts of FIGS. 5A and 5B will be described more specifically. Now, assume that the image indicated by the CMYKLCLM multivalued image data obtained by the conversion in the multivalued color conversion process in S801 is a letter “T” formed of the black ink and the cyan ink, for example. FIG. 16B illustrates a part of the piece of binary image data (ejection data) on the black ink obtained by the conversion in the binarization process in S802 in this case. In FIG. 16B, each blacked-out pixel represents a pixel where the ink is to be ejected. In this embodiment, the matrices with 16 vertical pixels×32 horizontal pixels illustrated in FIG. 16A are predetermined regions, and these matrices are allocated to the piece of binary image data on the black ink in the process in S803. Then, the number of dots to be printed in each matrix is counted for each ink color based on the corresponding piece of binary image data. Note that the maximum number of dots that can be formed in a single matrix with an ink of a single color is 512 dots. As many pieces of ejection data as the number of inks are generated substantially simultaneously. Thus, the total number of dots to be printed in each matrix (total dot number) can be calculated by summing up the dot numbers of all inks. The calculated dot number is stored in the RAM or the like. Note that not only the total dot number but also the count value of each ink may be stored simultaneously.

In this embodiment, the ink application duty is 100% in a case where a single dot of an ink is ejected in every pixel in a matrix and all pixels are blacked out. Here, it is assumed that the ink application duty of the image a is approximately 130%, and the ink application duty of the image β at another position is 100%. In addition, the distance from the image a to the image β is equivalent to the distance from the print heads 22 to the heating unit 56, as illustrated in FIG. 7.

In this case, as illustrated in FIG. 7, the process in S804 is performed at the timing at which the image a enters the heating unit 56 or at a timing before it. Specifically, in S804, it is determined whether the largest value among the total dot count values corresponding to the plurality of matrices included in the image a and lying side by side in the main scanning direction is less than a 120% duty, which is a predetermined value (threshold value) set in advance. The image a has been stored as an image containing an approximately 130%-duty matrix in the process in S803. Thus, the processing proceeds to step S805.

In S805, a printing mode is selected in which the time for which the images in the predetermined regions will be heated by the heating unit 56 (heating time) is longer than that in a case of implementing the normal printing mode. In this embodiment, a printing mode is selected which uses such mask patterns that the number of scans (number of passes) required to complete the image is greater than that in the normal printing mode. Specifically, the 6-pass printing mode, in which an image in each main scan region is completed with six main scans, is selected in the case of the normal printing mode, whereas the 8-pass printing mode, in which an image in each main scan region is completed with eight scans in total, is selected in the case of S805.

The printing mode is changed to the 8-pass printing mode selected in S805 at the timing at which the image a enters the heating unit 56. In this case, the part to be printed in the 8-pass printing mode is the image β. As a result of changing from the normal printing mode (6-pass printing mode) to the 8-pass printing mode, the heating time for the image a at the heating unit 56 becomes 1.4 times the heating time in the 6-pass printing mode. In this case, the image β will be printed in the 8-pass printing mode. Thereafter, the printing mode returns to the normal 6-pass printing mode from the 8-pass printing mode at the timing at which a high-duty matrix included in the image a exits the heating unit 56. However, the 8-pass printing is continued in a case where another high-duty matrix with a 120% duty or higher has already entered the heating unit 56 at the point when the high-duty matrix included in the image a exits the heating unit 56. Then, the printing mode switches from the 8-pass printing mode to the 6-pass printing mode at the point when the duty of all matrices included in the image located in the heating unit 56 becomes less than 120%.

Meanwhile, after the completion of the printing operation by the print heads 22, the operation of conveying the print medium 1 may be performed in an intermittent manner as in the printing operation, but may be performed in a continuous manner. In either case, however, the conveyance speed of the print medium needs to be controlled so as to ensure a sufficient heating time for the image passing through the heating unit 56. Specifically, in a case where a high-duty matrix is present in an image located upstream of the heating unit 56 at the time of completion of the printing operation, the operation of conveying the print medium 1 needs to be controlled so as to heat this matrix for a sufficient heating time as in the printing operation. For example, in a case of conveying the print medium in an intermittent manner also after the completion of the printing operation, the conveyance operation is performed at pitches similar to those in the 8-pass printing from the point when the image including the high-duty matrix enters the heating unit 56. In a case of conveying the print medium 1 in a continuous manner after the completion of the printing operation, the operation of conveying the print medium 1 is performed at such a speed as to ensure a heating time similar to that in the 8-pass printing for the high-duty matrix.

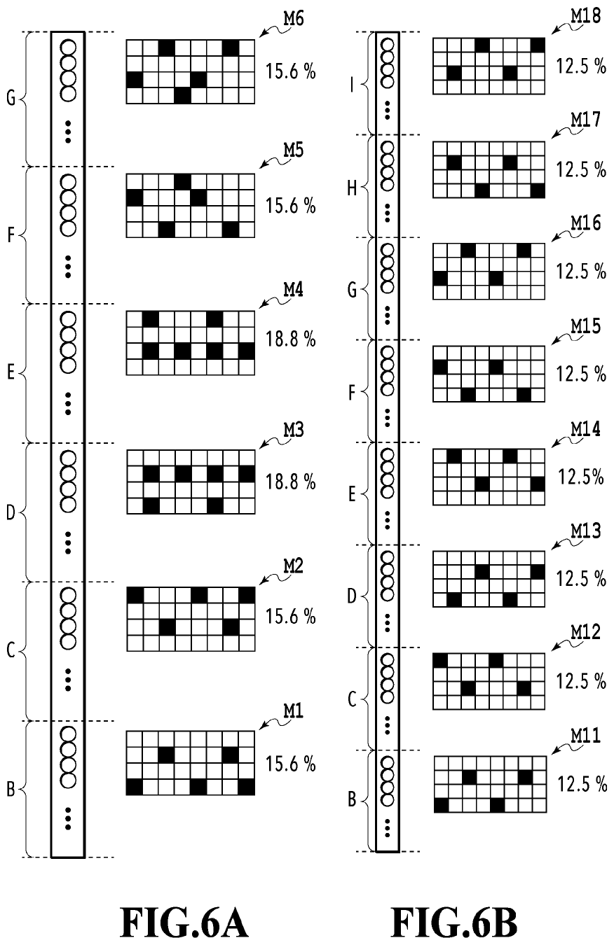

Now, the mask patterns used in the mask pattern process in S808 will be described with reference to FIGS. 6A and 6B. FIG. 6A is a diagram illustrating the mask patterns used in the 6-pass printing mode, which represents a normal printing operation. The mask patterns illustrated in FIG. 6A are mask patterns that distribute pieces of data to a pixel group of 8×4 dots so as to complete an image with six scans in total. A mask M1 corresponding to the bottom pixel group among the illustrated six pixel groups of 8×4 dots in the diagram is a mask for generating a piece of ejection data for performing the first printing scan. A mask M2 is a mask for generating a piece of ejection data for the second printing scan. Similarly, M3, M4, M5, and M6 denote masks for generating pieces of ejection data to be used in the third, fourth, fifth, and sixth printing scans, respectively. The blacked-out portions of each mask correspond to pixels where the ink is ejected. This means that a pixel group of 8×4 dots to be printed with image data subjected to the mask process with the six masks M1 to M6 can be printed at a 100% duty. Note that a main scan of the print heads performed in a state where the print heads can print dots onto a print medium will be referred to as a printing scan in the following description.

By performing AND processing on part of the piece of binary image data on each of C, M, Y, K, LC, and LM (e.g., the piece of binary image data corresponding to a region of 8×4 dots) and the mask for each printing scan (pass), a piece of ejection data for applying the ink in each printing scan can be generated. The mask patterns illustrated in FIG. 6A are patterns that distribute an ink application amount substantially evenly in the respective printing scans. Thus, in the case of using these mask patterns, the ink is ejected substantially evenly from the entire ejection opening array of the print head 22. Note that these mask patterns are used such that the same mask patterns are repeatedly used in the same scan region across the entire width of the print medium. Therefore, the ink application amount does not change between pixel groups of 8×4 dots in the same scan region.

FIG. 6B represents mask patterns that distribute pieces of data to a pixel group of 8×4 dots so as to complete an image in a scan region with eight scans in total. These mask patterns M11 to M18 are similar to the masks M1 to M6 illustrated in FIG. 6A except that the ratio of pieces of data distributed to each scan is different. Thus, detail description is omitted here.

As mentioned earlier, performing printing on a non-permeable print medium such as a PVC sheet with ink may result in “defective fixing (defective curing, defective scratch resistance)”. A main cause of this “defective fixing” is that, in a case where ink is applied at a high application ratio onto a PVC sheet, the heating of the fine resin particles contained in the ink will be insufficient and the resin will not be sufficiently melted, which will result in a failure to form a film with high scratch resistance. In this embodiment, the heating temperature of the heating unit on the PVC sheet is set at approximately 100° C. in consideration of ink film formability and productivity in printing a plurality of generally printed images in the 6-pass printing mode.

As a result of studying the application ratio of an ink (ink application duty) applied to generally used images, it was found that the ink application ratio in many predetermined regions (matrices) in each image was a 120% duty or lower. In a case where the ink application ratio is a 120% duty or lower, sufficient ink film formability was achieved by setting the heating temperature of the heating unit 56 at 100° C. The ink film formability was determined by making scratch resistance evaluations. The evaluation apparatus used in this determination is an apparatus complying with the type II (JSPS type) rubbing test specified in the Japanese Industrial Standard, L—Textile engineering, Test Methods for Colour Fastness to Rubbing (JIS L 0849) (Feb. 20, 2013). This has generally been used in ink “rubbing-wear resistance tests” as well. A solid image of the magenta ink was printed on a PVC sheet on a curved surface with the ink application amount varied. A test piece fixed onto this image by heating was attached, and the test piece and a piece of white cotton cloth fixed to a friction block were rubbed against each other in a reciprocating manner 150 times. Then, the ink residual ratio (the ratio of the original density and the residual density) was measured. The results are shown in Tables 1 to 3.

TABLE 1
Case in Which Heating Temperature Was Set at Approximately 80° C.

| Ink Application Ratio | 90% | 100% | 110% | 120% | 130% |
|---|---|---|---|---|---|
| Ink Residual Ratio | Approx. | Approx. | Approx. | Approx. | Approx. |
| | 90% | 75% | 75% | 65% | 60% |
| Scratch Resistance | GOOD | BAD | BAD | BAD | BAD |
| Evaluation Result | | | | | |

TABLE 2
Case in Which Heating Temperature Was Set at Approximately 100° C.

| Ink Application Ratio | 90% | 100% | 110% | 120% | 130% |
|---|---|---|---|---|---|
| Ink Residual Ratio | Approx. | Approx. | Approx. | Approx. | Approx. |
| | 100% | 100% | 95% | 90% | 80% |
| Scratch Resistance | GOOD | GOOD | GOOD | GOOD | BAD |
| Evaluation Result | | | | | |

TABLE 3
Case in Which Heating Temperature Was Set at Approximately 120° C.

| Ink Application Ratio | 90% | 100% | 110% | 120% | 130% |
|---|---|---|---|---|---|
| Ink Residual Ratio | Approx. | Approx. | Approx. | Approx. | Approx. |
| | 100% | 100% | 100% | 100% | 95% |
| Scratch Resistance | GOOD | GOOD | GOOD | GOOD | GOOD |
| Evaluation Result | | | | | |

The scratch resistance evaluations were made based on an ink residual ratio of 90% as a threshold value such that an ink residual ratio greater than 90% was evaluated as “GOOD” and an ink residual ratio less than 90% was evaluated as “BAD”. The results in Table 1 indicate that in a case of setting the heating temperature of the heating unit on the PVC sheet at approximately 80° C., a plurality of printed images and regions may have a fixing issue. On the other hand, as shown in Table 2, setting the heating temperature of the heating unit on the PVC sheet at approximately 100° C. allows many of printed images and regions to avoid the fixing issue, so that both the scratch resistance and productivity are satisfied. However, it can be understood from the results in Table 2 that setting the heating temperature at approximately 100° C. entails a possibility of defective scratch resistance, although the rate of occurrence is low, in a case where the image partially include a region where the ink application ratio is above a 120% duty, e.g., a 130%-duty region.

Also, the results in Table 3 indicate that a region where the ink application ratio is a 130% duty can be handled by setting the heating temperature at approximately 120° C. However, applying heat around this temperature to the PVC sheet beyond necessity may cause an issue of deformation such as stretch or shrinkage of the PVC sheet.

In view of the above, in this embodiment, a printing method is implemented in which the heating temperature of the heating unit on a PVC sheet is set at approximately 100° C. yet good scratch resistance can still be achieved also at regions where the ink application amount is a 130% duty and therefore both the scratch resistance and productivity can be satisfied. Table 4 shows the results of scratch resistance evaluations obtained by this embodiment. Note that the results shown in Table 4 were obtained by evaluating the scratch resistance with the heating temperature of the heating unit on the PVC sheet set at approximately 100° C. and the number of scans in a bidirectional multipass printing mode varied.

TABLE 4
Case in Which Heating Temperature Was Set at Approximately 100° C.
and Ink Application Amount Was set at 130% Duty

| | Total Number of Printing Scans | | | | |
|---|---|---|---|---|---|
| | 4 | 6 | 8 | 12 | 16 |
| Ink Residual Ratio | Approx. | Approx. | Approx. | Approx. | Approx. |
| | 60% | 80% | 90% | 100% | 100% |
| Scratch Resistance | BAD | BAD | GOOD | GOOD | GOOD |
| Evaluation Result | | | | | |

As shown in Table 4, it can be seen that increasing the number of scans in the bidirectional multipass printing mode raises the ink residual ratio also in a case where the heating temperature is approximately 100° C. and the ink application ratio is a 130% duty. This indicates that the scratch resistance evaluation result gets better as the time for which the image region passes the heating unit (heating time) gets longer. For example, as compared to the heating time in a case of implementing the 6-pass printing mode, in which an image in a scan region is completed with six printing scans, the heating time in a case of forming an image in the 8-pass printing mode is approximately 1.4 times longer. Accordingly, implementing the 8-pass printing mode gives a better scratch resistance evaluation result.

Note that if all images are printed in the 8-pass printing mode, that apparatus' productivity will drop to be 0.75 times the productivity in a case of printing all images in the 6-pass printing mode. For this reason, in this embodiment, the printing mode is controlled such that the 6-pass printing mode is implemented while a region where the application ratio of the ink applied onto the PVC sheet is lower than a 120% duty passes through the heater, whereas the 8-pass printing mode is implemented while a region with a 120% duty or higher passes through the heater. Thus, according to this embodiment, both the scratch resistance and productivity of printed images are satisfied.

### (Printing Operation)

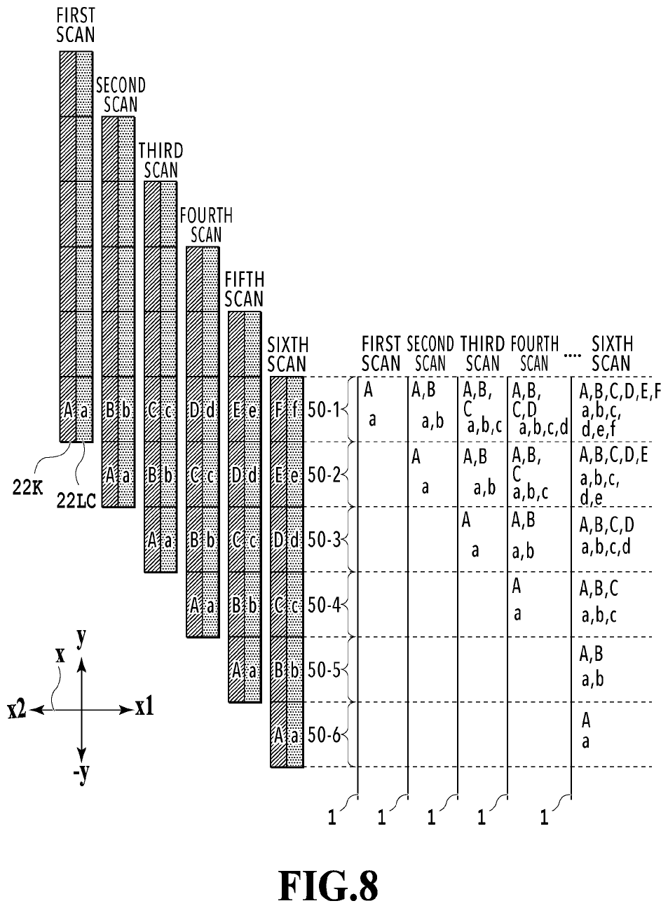

Now, a basic operation in multipass printing executed by the printing apparatus in this embodiment will be described by using FIG. 8. As in the above, in this embodiment, printing is performed with the printing mode switched between the bidirectional 6-pass printing mode and the bidirectional 8-pass printing mode as appropriate. Since the basic operation in the 6-pass printing mode and the basic operation in the 8-pass printing mode are similar except that the number of passes is different, the description will be given here by taking the 6-pass printing mode as an example.

In the 6-pass printing mode, printing is performed based on pieces of ejection data generated using the above-mentioned mask patterns illustrated in FIG. 6A. In this case, six ejection opening groups are set in the ejection opening array of each print head 22. For example, the print head 22K for ejecting the black (K) ink is provided with an ejection opening array including 1248 ejection openings, and this ejection opening array is divided into 6 ejection opening groups each including 208 ejection openings. This also applies to the print heads for ejecting the inks of the other colors. FIG. 8 illustrates an example of performing printing by using the print head 22K for ejecting the black (K) ink and the print head 22LC for ejecting the light cyan (LC) ink.

Firstly, in the first scan, the inks are ejected from first ejection opening groups A and a of the print heads 22K and 22LC based on the pieces of ejection data for the first scan to thereby print an image in a print region 50-1. Then, the print medium 1 is conveyed in the sub-scanning direction (y direction) by ⅙ of the length of the print heads 22K and 22LC (by the length of a single ejection opening group). Note that in FIG. 8, the print heads 22K and 22LC are illustrated as moving relative to the print medium 1 in the opposite direction (−y direction) from the sub-scanning direction to indicate the positional relationship between the print medium 1 and the print heads 22K and 22LC.

Then, in the second scan, the inks are ejected from second ejection opening groups B and b of the print heads 22K and 22LC based on the pieces of ejection data for the second scan to thereby perform printing on the print region 50-1. Further, during this second scan, the inks are ejected also from the first ejection opening groups A and a based on pieces of ejection data to thereby print an image in a print region 50-2 as well.

Then, the print medium 1 is conveyed in the sub-scanning direction by ⅙ of the length of the print heads. Thereafter, the third scan is performed. In the third scan, the inks are ejected from third ejection opening groups C and c of the print heads 22K and 22LC based on the pieces of ejection data for the third scan of the print region 50-1 to thereby print an image in the print region 50-1. Also, during this third scan, the inks are ejected also from the second ejection opening groups B and b and the first ejection opening groups A and a of the print heads 22K and 22LC based on pieces of ejection data. As a result, images are printed in the print regions 50-2 and 50-3 as well.

Then, the print medium 1 is conveyed in the sub-scanning direction by ⅙ of the length of the print heads. Thereafter, the fourth scan is performed. In the fourth scan, the inks are ejected from fourth ejection opening groups D and d of the print heads 22K and 22LC based on the pieces of ejection data for the fourth scan to thereby print an image in the print region 50-1. Also, during this fourth scan, the inks are ejected also from the third ejection opening groups C and c, the second ejection opening groups B and b, and the first ejection opening groups A and a of the print heads 22K and 22LC based on pieces of ejection data. As a result, images are printed in the print regions 50-2, 50-3, and 50-4 as well.

Then, the print medium 1 is conveyed in the sub-scanning direction by ⅙ of the length of the print heads. Thereafter, the fifth scan is performed. In the fifth scan, the inks are ejected from fifth ejection opening groups E and e of the print heads 22K and 22LC based on the pieces of ejection data for the fifth scan to thereby print an image in the print region 50-1. Also, during this fifth scan, the inks are ejected also from the fourth ejection opening groups D and d, the third ejection opening groups C and c, the second ejection opening groups B and b, and the first ejection opening groups A and a of the print heads 22K and 22LC based on pieces of ejection data. As a result, images are printed in the print regions 50-2, 50-3, 50-4, and 50-5 as well.

Then, the print medium 1 is conveyed in the sub-scanning direction by ⅙ of the length of the print heads. Thereafter, the sixth scan is performed. In the sixth scan, the inks are ejected from sixth ejection opening groups F and f of the print heads 22K and 22LC based on the pieces of ejection data for the sixth scan to thereby print an image in the print region 50-1. Also, during this sixth scan, the inks are ejected also from the fifth ejection opening groups E and e, the fourth ejection opening groups D and d, the third ejection opening groups C and c, the second ejection opening groups B and b, and the first ejection opening groups A and a of the print heads 22K and 22LC based on pieces of ejection data. As a result, images are printed in the print regions 50-2, 50-3, 50-4, 50-5, and 50-6 as well.

By performing the above first to sixth scans, the image to be formed in the print region 50-1 is completed. In addition, the images to be printed in the print regions 50-2 to 50-6 will be sequentially completed by repeating scans similar to the above after the sixth scan.

As described above, in this embodiment, while a predetermined region with a large ink application amount passes through the heater, a printing operation is performed using multipass printing involving a larger number of scans than the multipass printing performed in the normal printing mode. Accordingly, the time for which the predetermined region with a large ink application amount passes through the heating unit, i.e., the heating time, can be made longer. This can remedy the issue of defective scratch resistance that has occurred in conventional apparatuses.

Meanwhile, this embodiment employs a configuration in which the printing mode is switched between the 6-pass printing mode, which is implemented as the normal printing mode, and the 8-pass printing mode as appropriate according to the ink application amount (ink application ratio) in each predetermined region in an image printed on the print medium. However, in a case where it is desired to enhance the scratch resistance of an image including a predetermined region with a high ink application ratio, a 12- or 16-pass printing mode, which can achieve good scratch resistance, as shown in the results in Table 4, may be implemented.

Furthermore, the scratch resistance of an image varies depending on the type and amount of the fine resin particles contained in the inks. It is therefore desirable not to limit the number of passes in the normal printing mode to six passes but to change it as appropriate according to the composition of the inks.

Also, in the above embodiment, an example has been shown in which in a case where the mode is switched, the mask patterns are switched to change the distribution of data in each scan. However, the method of switching the data distribution is not limited to the method utilizing mask patterns, but another method can be used.

### Second Embodiment

Next, a second embodiment of the present disclosure will be described. In the first embodiment, control is performed in which a printing mode in which an image is completed with six main scans is set while a low-duty image portion passes through the heating unit, and a printing mode in which an image is completed with eight scans is set while a high-duty image portion passes through the heating unit. In contrast, in this embodiment, control is performed in which a printing mode in which an image is completed with six scans is set while a low-duty image portion passes through the heating unit, and a printing mode in which a wait time is provided for each of six scans until the next scan is set while a high-duty image portion passes through the heating unit. In this way, the time for which a predetermined region having a possibility of experiencing a “defective fixing (defective curing, defective scratch resistance)” phenomenon passes through the heating unit can be made longer. In the following, the control performed in this embodiment will be described, focusing on the difference from the first embodiment.

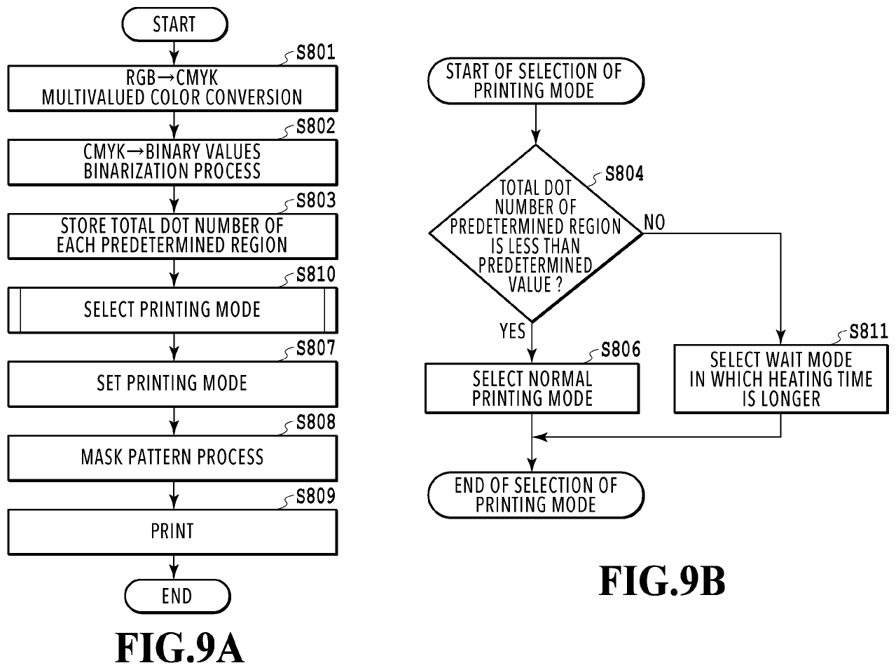

In this embodiment too, the printing apparatus has the configuration illustrated in FIGS. 1 to 4 and 7 and performs processing along flowcharts illustrated in FIGS. 9A and 9B. Note that the processes in S801 to S809 in the flowcharts of FIGS. 9A and 9B are similar to those processes illustrated in FIGS. 5A and 5B. In S804 in FIG. 9B, as in the first embodiment, it is determined whether the largest value among the total dot count values of the plurality of matrices included in the image a and lying side by side in the main scanning direction is less than a 120% duty, which is a threshold value, at the timing at which the image a enters the heating unit or at a timing before it. As in the above, the image a has been stored as an image with an approximately 130% duty. The result of the determination in S804 is therefore NO, and the processing proceeds to S811, in which a wait mode is selected so that the heating time at the heating unit 56 will be longer.

In the wait mode in this embodiment, a wait time in which the print heads 22 wait at rest without ejecting the inks is provided for each of six scans until the next scan. This wait time is provided before the print heads start a printing scan in the main scanning direction or after the print heads finish it. An end position in the printing apparatus, e.g., the home position or the like, is preferably set as the wait position.

The timing at which to switch the printing operation mode from the normal printing mode (first printing mode) to the wait mode (second printing mode) is similar to that in the first embodiment. Specifically, the mode is switched to the wait mode at the timing at which the high-duty image a enters the heating unit 56. In addition, this wait time for the print heads 22 is preferably determined as appropriate according to the composition, type, and the like of the inks to be used. To properly fix the high-duty (130%-duty) image a with the heating unit 56, the heating time is preferably increased to be about 1.4 times the heating time in the normal printing mode. Here, the wait time is set at approximately 2 seconds in this embodiment. Note that in the normal printing mode selected in S806, no wait time is set between each main scan and the next main scan. In other words, the wait time is 0 second.

While the image a is present in the heating unit 56, the image β is printed in the wait mode, in which an approximately 2-second wait time is provided for each of six scans. Then, the printing mode returns to the normal printing mode, in which no wait time is provided, at the timing at which the image a exits the heating unit 56.

As described above, in this embodiment, the wait mode, in which a wait time is provided, is implemented while an image including a region printed at a high duty passes through the heater. Accordingly, the heating time for the image printed at a high duty can be made longer. This can remedy the issue of defective scratch resistance. In addition, after the image printed at a high duty finishes passing through the heating unit, the printing mode returns to the normal printing mode and the printing is performed at high speed. This makes it possible to minimize the decrease in productivity.

Meanwhile, in this embodiment, an example has been shown in which no wait time is set between main scans (wait time=0 second) in the normal printing mode whereas the wait time is set at 2 seconds in the wait mode. However, a wait time other than 0 second can be set between main scans in the normal printing mode as well. Specifically, a wait time of t1 seconds (t1>0) can be provided between main scans in the normal printing mode, and a wait time t2 longer than t1 seconds (t2>t1) can be provided between main scans in the wait mode. The wait times t1 and t2 may each be set as appropriate according to the ink application amount, the ink composition, the ink type, and the like.

### Third Embodiment

Next, a third embodiment of the present disclosure will be described. In the above second embodiment, an example has been shown in which the printing mode is switched between the normal printing mode and the wait mode to switch the wait time in the printing of the image β between two levels (0 second and 2 seconds). In contrast, in this embodiment, the wait time in the wait mode is increased or decreased in a stepwise manner according to the position of the image a relative to the heater 26. Specifically, printing in the wait mode, in which a wait time is provided, is started before the entry of the image a into the space immediate under the heater by a predetermined number of scans, and the wait time is then increased after each scan. Further, after the exit of the image α from the space immediately under the heater 26, the printing in the wait mode, in which a wait time is provided, is continued for a predetermined number of scans and the wait time is shortened after each scan. In this way, image unevenness due to the wait time varying for each scan in the multipass printing can be made less noticeable.

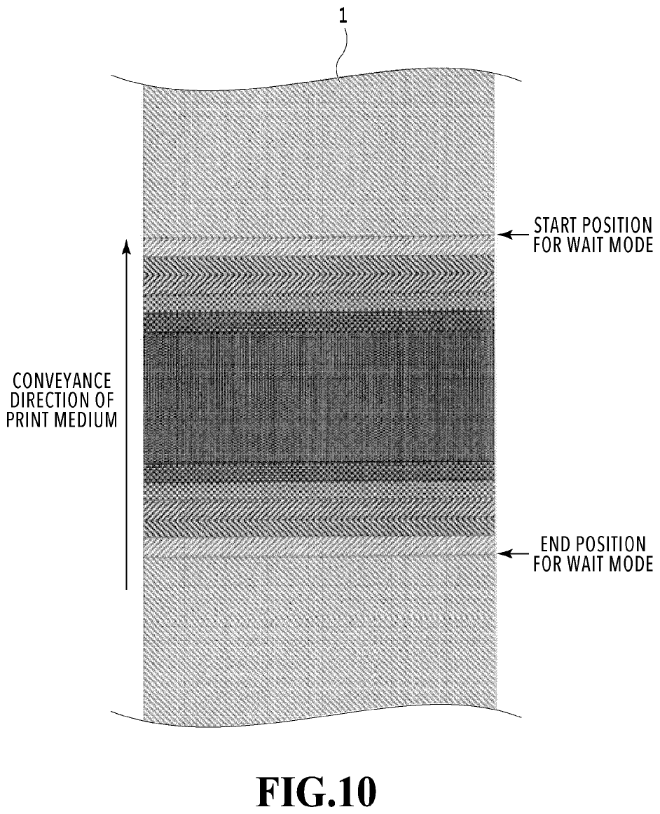

Now, the occurrence of image unevenness due to a time difference in multipass printing will be described. In multipass printing, while an ink ejected in a main scan dries and forms a dot on a print medium, an ink ejected in the next main scan lands on the same position and gets mixed with the ink having landed in the preceding main scan. Here, the degree of mixing of the inks varies depending on the difference between the landing timings, that is, the time difference between the main scans. Thus, if the time difference between main scans is not constant, there will be a difference in the degree of mixing of inks ejected in successive main scans, which may cause image unevenness. For example, in a case where the printing mode is switched to the wait mode, thereby inserting a 2-second wait time between scans, in the middle of forming a 50%-duty image in the 6-pass printing mode, in which an image is completed with six scans, image unevenness as illustrated in FIG. 10 may occur, causing gradual changes in the image. Thus, in this embodiment, the wait time in the wait mode is varied in a stepwise manner as mentioned above to suppress the image unevenness.

Table 5 is a table in which wait times are set for scans in a case where the printed image α being a high-duty image is present during the 6-pass multipass printing with which image unevenness is suppressed. Assuming that the scan at the timing at which the image α enters the space immediately under the heater 26 is a 0th scan, scans before the entry of the image α into the space immediately under the heater will be expressed as negative (−) scans. After a negative scan is finished, the print heads are stopped for the wait time set for this negative scan. In addition, while the image α passes through the heater, the print heads are stopped for the wait time set for the 0th scan. Further, assuming that the scan at the timing at which the image α exits the space immediately under the heater is a 0th scan, the print heads are stopped for the wait time set for the 0th scan. Further, assuming that scans after the exit of the image α from the space immediately under the heater are positive (+) scans, the print heads are stopped for the wait time set for a positive scan after it is finished. During each wait time, the print heads are stopped at one of two end portions of the main scan region. As described above, in this embodiment, the wait mode (second printing mode) is implemented in specific regions including: the region (predetermined region) in the image α where the ink application amount is a predetermined value or greater; the region where the negative scans are performed (first main scan region); and the region where the positive scans are performed (second main scan region). Also, the first printing mode, in which no wait time is provided after the end of each main scan, is implemented in the regions other than the specific regions including the above three regions.

TABLE 5
Wait Times for Scans in 6-Pass Multipass Printing

| Scan Timing | |
|---|---|
| (Position of Image α) | Wait Time |
| −11th and preceding scans | +0 second |
| −10th scan | +0.5 second |
| −9th scan | +0.5 second |
| −8th scan | +0.5 second |
| −7th scan | +1 second |
| −6th scan | +1 second |
| −5th scan | +1 second |
| −4th scan | +1 second |
| −3rd scan | +1.5 seconds |
| −2nd scan | +1.5 seconds |
| −1st scan | +1.5 seconds |
| 0th scan (the timing at which | +2 seconds |
| the image α enters the space | |
| immediately under the | |
| heater) | |
| 0th scan (the image α is | +2 seconds |
| passing through the heater) | |
| 0th scan (the timing at which | +2 seconds |
| the image α exits the space | |
| immediately under the | |
| heater) | |
| +1st scan | +1.5 seconds |
| +2nd scan | +1.5 seconds |
| +3rd scan | +1.5 seconds |
| +4th scan | +1 second |
| +5th scan | +1 second |
| +6th scan | +1 second |
| +7th scan | +1 second |
| +8th scan | +0.5 second |
| +9th scan | +0.5 second |
| +10th scan | +0.5 second |
| +11th and subsequent scans | +0 second |

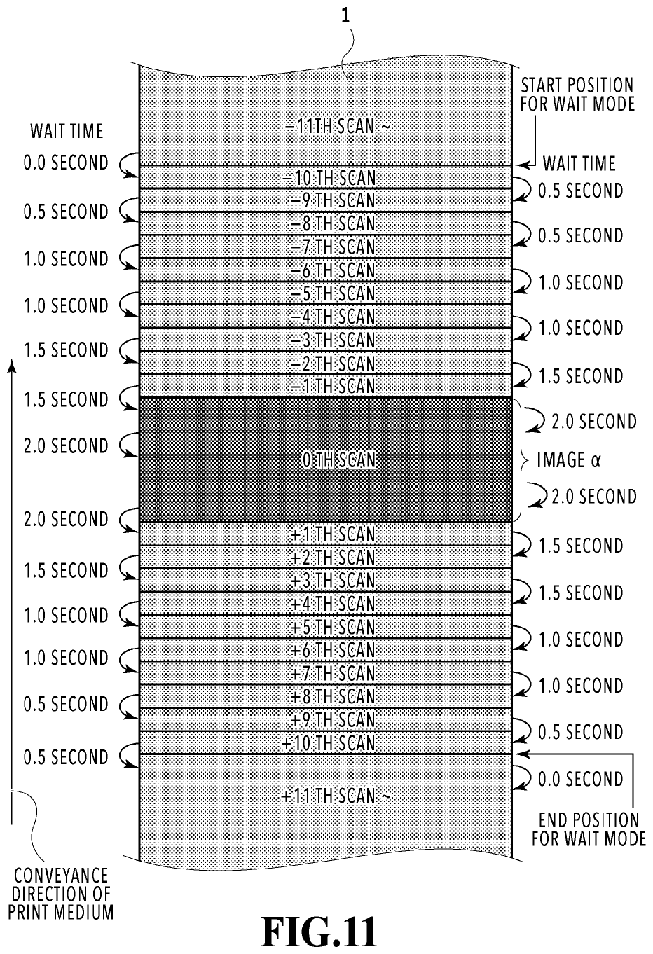

FIG. 11 is a diagram illustrating the wait times for scans in a case of implementing the wait mode in this embodiment. As illustrated in FIG. 11, assuming that the scan at the timing at which the image α enters the space immediately under the heater 26 is a 0th scan, the wait time is +0 second up to the 11th preceding scan (−11th scan) since the printing is performed in the normal printing mode up to this point. From the 10th preceding scan (−10th scan), the printing mode is switched to the wait mode in order to suppress image unevenness. A wait time of +0.5 second is provided for the −10th to −8th scans, a wait time of +1 second is provided for the −7th to −4th scans, and a wait time of +1.5 seconds is provided for the −3rd to −1st scans. For each 0th scan in the period from the entry of the image α into the space immediately under the heater to the exit from it, a wait time of +2 seconds is provided to sufficiently heat the image α, which is a high-duty image. Then, after the exit of the image α from the space immediately under the heater, a wait time of +1.5 seconds is provided for the +1st to +3rd scans, a wait time of +1 second is provided for the +4th to +7th scans, and a wait time of +0.5 second is provided for the +8th to +10th scans. From the +11th scan, the printing mode is switched to the normal printing mode, so that the wait time is set back to +0 second.

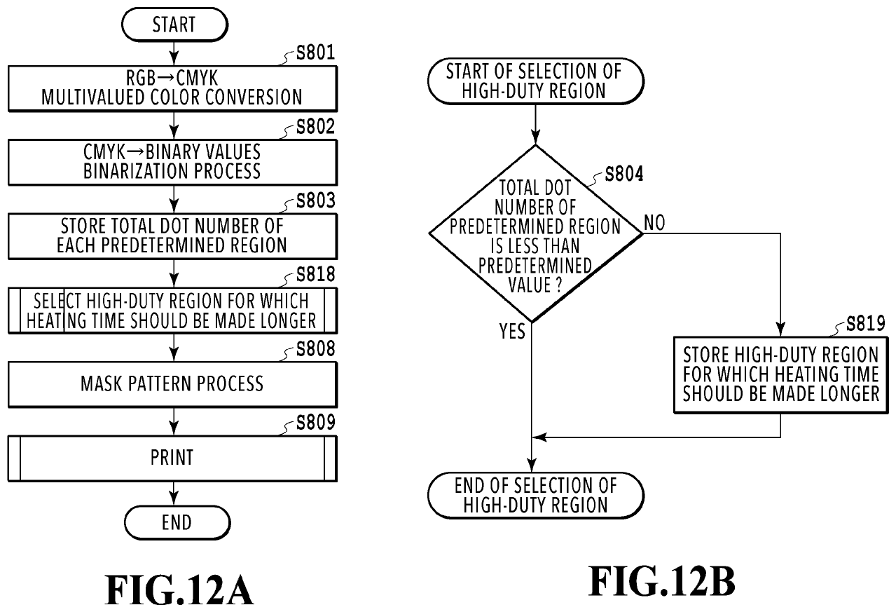

FIGS. 12A and 12B are flowcharts specifically illustrating the above processing. Note that the processes in S801 to S809 in the flowcharts of FIGS. 12A and 12B are similar to those processes illustrated in FIGS. 5A and 5B. In S818 in FIG. 12A, a high-duty region for which the heating time should be made longer is selected based on the dot count value of each predetermined region obtained in S803. More specifically, the processing illustrated in FIG. 12B is performed. In S804 in FIG. 12B, it is determined whether the largest value among the total dot count values of the plurality of matrices included in the image α and lying side by side in the main scanning direction is less than a 120% duty, which is a threshold value, at the timing at which the image α enters the heating unit. As in the above, the image α has been stored as an image with an approximately 130% duty. The result of the determination in S804 is therefore NO, and the processing proceeds to S819. In S819, the region is stored as a region for which the heating time at the heating unit 56 is to be longer.

In the printing operation in S809, a wait mode is implemented in which, assuming that the scan for the region stored in S819 is a 0th scan, a wait time for which the print heads 22 wait at rest without ejecting the inks is provided for each of preceding and subsequent scans until the next scan. For example, in the case of 6-pass printing, in which an image is completed with six scans, wait times are provided for the 10th preceding scan before the entry of the image α into the heating unit through the 10th subsequent scan after the exit of the image α from the heating unit.

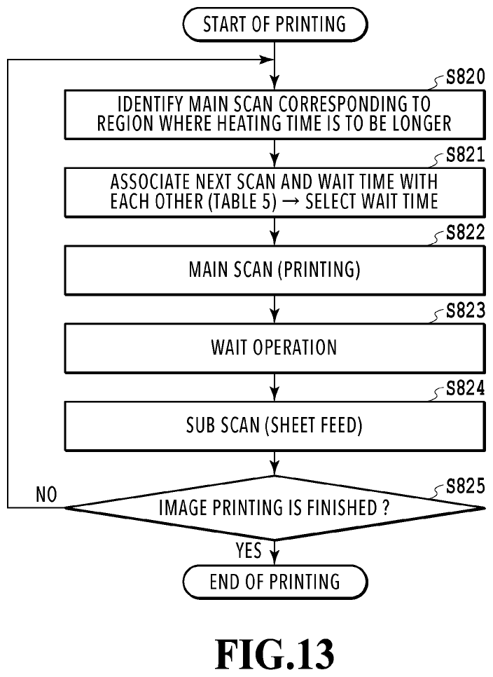

Specifically, processing illustrated in a flowchart of FIG. 13 is performed. First in S820, the main scan corresponding to the region where the heating time is to be longer is identified. Specifically, the main scan at the entry of the image α into the heater 26 through the printing scan at the exit from the heater 26 are assumed as the 0th scans. Then in S821, with scans preceding the 0th scans as negative (−) scans and scans following the 0th scans as positive (+) scans, the prestored scans and wait times in Table 5 are associated with each other. That is, wait times are selected. Then, a main scan (printing) is performed in S822, and a wait operation is performed for the set wait time in S823. Then, a sub scan (sheet feed) is performed in S824. The above processes in S820 to S824 are repeated until it is determined in S825 that the image is finished.

As described above, in the third embodiment, while preceding and subsequent images including a region printed at a high duty pass through the heater 26, printing is performed with a corresponding wait time provided for each scan. Specifically, a wait time is set for several scans preceding the entry of the image α into the space immediately under the heater, and the wait time is made longer after each scan. In this way, image unevenness can be suppressed. Similarly, instead of returning the printing mode to the normal printing mode at the timing at which the image α being a high-duty image exits the space immediately under the heater 26, a wait time is set for several scans following the exit of the image α from the space immediately under the heater, and the wait time is made shorter after each scan. Accordingly, it is possible to minimize the issue of defective scratch resistance of the image α and the decrease in productivity and to reduce the image unevenness.

### Fourth Embodiment

Next, a fourth embodiment of the present disclosure will be described. In this embodiment, while an image including a region printed at a low duty passes through the heating unit, bidirectional printing is performed in the normal printing mode. On the other hand, while an image portion including a region printed at a high duty passes through the heating unit, a printing mode using unidirectional scans is implemented. The control performed in this embodiment will be more specifically described below.

In this embodiment too, the printing apparatus has the configuration illustrated in FIGS. 1 to 4 and 7 and performs processing along the flowcharts illustrated in FIGS. 5A and 5B. However, the difference from the foregoing embodiment is that the low-speed printing mode set in S805 in FIG. 5B is unidirectional printing. In S804 in FIG. 5B, as in the first embodiment, it is determined whether the largest value among the total dot count values of the plurality of matrices included in the image α and lying side by side in the main scanning direction is less than a 120% duty, which is a threshold value. If the duty of the image α is 120% or higher, the processing proceeds to S805, in which unidirectional printing is selected as the low-speed printing mode to make the heating time at the heating unit 56 longer. The change from the bidirectional printing, which is the normal printing mode, to the unidirectional printing, which is the low-speed printing mode, is done at the timing at which the image α including a high-duty region enters the heating unit, as in the first embodiment. Then, the printing is returned to the bidirectional printing from the unidirectional printing at the timing at which the image α exits the heating unit 56.

Now, an overview of a printing operation with unidirectional scans will be described with reference to FIG. 8. Firstly, in the first scan (first forward scan), the inks are ejected from the first ejection opening groups A and a of the print heads 22K and 22LC based on the pieces of ejection data for the first scan to thereby print an image in the ejection print region 50-1.

Then, the print heads 22K and 22LC are moved in the direction opposite from the direction in the first printing scan (first backward scan) to be returned to the start position for the first forward scan. During this first backward scan, the inks are not ejected from the print heads 22K and 22LC. In addition, in FIG. 8, the print medium 1 is not conveyed in the sub-scanning direction between the first forward scan and the first backward scan.

After the print heads 22K and 22LC return to the start position for the first forward scan, the print medium 1 is conveyed in the sub-scanning direction (the direction of the arrow y) by ⅙ of the length of the print heads 22K and 22LC. As a result, the positional relationship between the print heads 22K and 22LC and the print medium becomes the positional relationship illustrated in the second scan (second forward scan) in FIG. 8.

Then, the print heads 22K and 22LC starts the second scan (second forward scan) in FIG. 8, in which the inks are ejected from the second ejection opening groups B and b of the print heads 22K and 22LC based on the pieces of ejection data for the second scan. During this second scan, the inks are ejected also from the first ejection opening groups A and a of the print heads 22K and 22LC to thereby print an image in the print region 50-2. Thereafter, the print heads 22K and 22LC perform the second backward scan, in which they move in the direction opposite from that in the second scan (second forward scan), to return to the start position for the second scan (second forward scan). The inks are not ejected during this second backward scan. Subsequently, similar scans are repeated.

As described above, in the unidirectional printing, the print medium is not conveyed between a forward scan and a backward scan. In other words, in the unidirectional printing, an operation of conveying the print medium is not performed without the print heads making a single reciprocal movement. Accordingly, in the unidirectional printing, the time taken to convey the print medium can be made longer than that in the bidirectional printing, in which an operation of conveying the print medium is performed between scans.

In sum, the bidirectional printing is performed as the normal printing mode while an image including a low-duty region passes through the heating unit 56, whereas the unidirectional printing is performed as the low-speed printing mode while an image including a high-duty region passes through the heating unit. In this way, the time for which a predetermined region having a possibility of experiencing a “defective fixing (defective curing, defective scratch resistance)” phenomenon passes through the heating unit can be made longer. This can remedy the issue of defective scratch resistance. In addition, after an image including a high-duty region finishes passing through the heating unit, the printing mode returns to the normal printing mode and the printing is performed at high speed. This makes it possible to minimize the decrease in productivity.

### Fifth Embodiment

Next, a fifth embodiment of the present disclosure will be described. In this embodiment, high-speed scan printing in which the print heads 22 are scanned at a relatively high speed is performed as a normal print mode while a low-duty image portion passes through the heating unit 56. On the other hand, while an image including a high-duty predetermined region (matrix) passes through the heating unit 56, low-speed scan printing in which the print head 22 are scanned at a lower speed than the normal movement speed is performed as a low-speed printing mode. In this way, the time for which a predetermined region having a possibility of experiencing “defective fixing (defective curing, defective scratch resistance)” passes through the heating unit 56 can be made longer. The control performed in this embodiment will be more specifically described below.

In this embodiment too, the printing apparatus has the configuration illustrated in FIGS. 1 to 4 and 7 and performs processing along the flowcharts illustrated in FIGS. 5A and 5B. If it is determined in S804 in FIG. 5B that the largest value among the total dot count values of a plurality of matrices included in the image α and lying side by side in the main scanning direction is higher than or equal to a 120% duty, which is a threshold value, the low-speed printing mode is selected in S805 so that the heating time at the heating unit 56 will be longer. In the low-speed printing mode in this embodiment, low-speed scan printing is performed in which the movement speed (scan speed) of the print heads 22 is lower than the scan speed in the normal printing mode. Note that in the low-speed scan printing, either the forward scan or the backward scan may be performed at low speed or both the forward scan and the backward scan may be performed at low speed.

Also, the change from the high-speed scan printing, which is the normal printing mode, to the low-speed scan printing, which is the low-speed printing mode, is done at the timing at which the image α including a high-duty matrix enters the heating unit, as in the foregoing embodiments. Then, the printing is returned to the high-speed scan printing from the low-speed scan printing at the timing at which the image α exits the heating unit 56.

Also, the scan speed of the print heads 22 in the low-speed scan printing is preferably determined as appropriate according to the composition, type, and the like of the inks to be used. As in the foregoing embodiments, to properly fix the image α including a high-duty (120% duty or higher) matrix with the heating unit 56, the heating time is preferably increased to be about 1.4 times the heating time in the normal printing mode. For this reason, in this embodiment, the scan speed of each print head 22 set in the low-speed printing mode is set to be (1/1.4) times the scan speed of each print head 22 set in the normal printing mode. This is achieved by controlling the rotational speed of the carriage motor 32 and the ink ejection frequency of the print heads.

While the image α passes through the heating unit 56, the image β is printed in the low-speed printing mode, in which the scan speed is (1/1.4) times the scan speed in the high-speed printing mode. Then, the printing mode returns to the high-speed printing mode, which is the normal printing mode, at the timing at which the image α exits the heating unit 56.

As described above, in this embodiment, while an image including a high-duty region passes through the heating unit, the low-speed scan printing is performed, so that the time for which the high-duty region passes through the heating unit (heating time) will be longer. This allows the inks in the high-duty region to be properly fixed to the print medium, and can therefore remedy the issue of defective scratch resistance of the image. Further, after the image including the high-duty region finishes passing through the heating unit, the printing mode returns to the normal printing mode and the printing is performed at high speed. This makes it possible to minimize the decrease in productivity.

### Sixth Embodiment

Next, a sixth embodiment of the present disclosure will be described. In the above first to fifth embodiments, examples have been shown in which the present disclosure is applied to a serial-type printing apparatus that performs printing via main scanning of the print heads 22. However, the present disclosure is also applicable to printing apparatuses of types other than the serial type. In the sixth embodiment, an example of applying the present disclosure to a full line-type printing apparatus will be described.

A full line-type printing apparatus is a printing apparatus employing a printing method in which long print heads having a length corresponding to the entire part of a print medium in its width direction (a direction orthogonal to the conveyance direction of the print medium) are held at a fixed position, and printing is performed by continuously conveying the print medium.

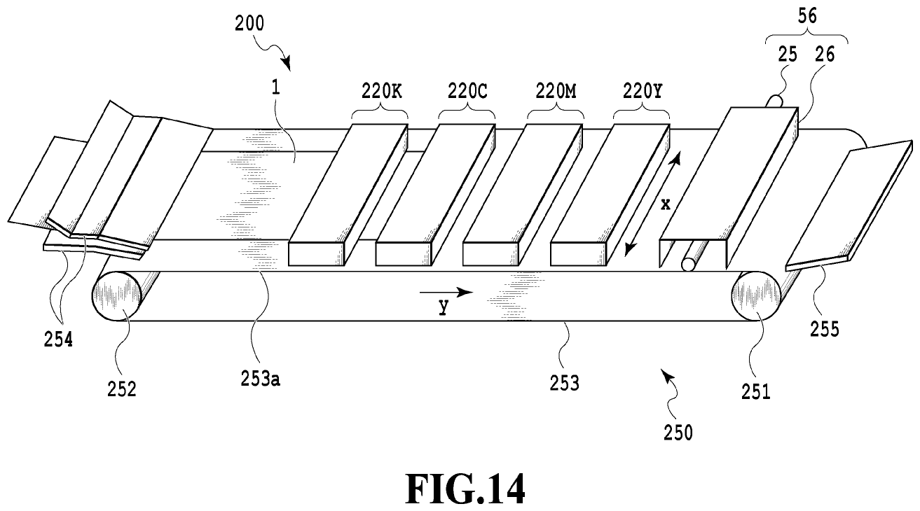

FIG. 14 is a perspective view schematically illustrating a configuration of a printing apparatus 200 in this embodiment. The printing apparatus 200 is a full line-type printing apparatus having a conveyance unit 250 that conveys a print medium and a printing unit 220. The conveyance unit 250 includes a conveyance motor not illustrated, a drive roller 251 that is rotated by this conveyance motor, a driven roller 252 disposed at a predetermined distance from the drive roller 251, and an endless conveyance belt 253 wound around both rollers 251 and 252. As the drive roller 251 is rotated by rotation of the conveyance motor, the conveyance belt 253 moves in a loop and its upper run 253a moves in the conveyance direction (y direction). A sheet feed guide 254 for feeding a print medium is provided on an upstream side of the conveyance belt 253. From this sheet feed guide 254, a print medium 1 placed on the upper run 253a of the conveyance belt 253 is conveyed in the y direction along with the upper run 253a and finally discharged onto a sheet discharge guide 255.

On the other hand, the printing unit includes print heads disposed so as to face the upper run of the conveyance belt 253. In this embodiment, four print heads 220K, 220C, 220M, and 220Y that eject black (K), cyan (C), magenta (M), and yellow (Y) inks, respectively, are disposed. In each print head, ejection openings for ejecting the ink are arrayed in a direction crossing the conveyance direction (y direction) (in this example, a direction orthogonal to the conveyance direction) across the entire part of the print medium in the width direction, forming a long ejection opening array.

Also, a heating unit 56 is disposed so as to face the upper run 253a of the conveyance belt 253 at a spatial region between the print head 220Y disposed on the most downstream side and the sheet discharge guide 255. The heating unit 56 in this embodiment includes a heater 25 and a heater cover 26, as with the heating unit 56 described in the foregoing embodiments.

In the full line-type printing apparatus, the print medium is continuously conveyed by the conveyance belt, and an image is continuously formed with the inks ejected from the ejection openings of the print heads. The image is completed at the point where it finishes passing through the print head 220Y disposed on the most downstream side, and the completed image enters the heating unit 56. The heating unit 56 heats the image that has entered it to fix the inks ejected onto the print medium 1. The print medium having passed the heating unit 56 is discharged to the outside via the sheet discharge guide 255.

The full line-type printing apparatus 200 configured as above can control the speed of printing of the print medium by controlling the rotational speed of the conveyance motor not illustrated, which moves the conveyance belt 253, and the ink ejection frequency of the print heads 220 (220K, 220C, 220M, 220Y). This control is performed by an MPU (control unit) not illustrated.

Meanwhile, in this embodiment too, the processes of S801 to S807 in the flowcharts illustrated in FIGS. 5A and 5B are performed in a similar manner. As illustrated in FIG. 7, the processing illustrated in FIG. 5B is performed at the timing at which the image α enters the space immediately under the heater or at a timing before it. Specifically, in S804, it is determined whether the largest value among the total dot count values of the plurality of matrices included in the image α and lying side by side in the main scanning direction is less than a 120% duty, which is a predetermined value (threshold value) set in advance. Then, if the image α does not include a high-duty region with an approximately 120% duty or higher, the processing proceeds to S806, in which a normal printing mode is selected. On the other hand, if the image α includes a high-duty region with an approximately 120% duty or higher, the processing proceeds to S805, in which a low-speed printing mode in which the heating time is longer is selected. The low-speed printing mode in this embodiment is implemented by making the conveyance speed of the print medium 1 lower than the conveyance speed in the normal printing mode and lowering the ink ejection frequency of the print heads 220.

Also, the change from the normal printing mode to the low-speed printing mode is done at the timing at which the image α including a high-duty matrix enters the heating unit, as in the foregoing embodiments. Then, the printing mode is returned to the normal printing mode from the low-speed printing mode at the timing at which the image α exits the heating unit 56.

Meanwhile, the movement speed of the conveyance belt 253 and the ink ejection frequency of the print heads in the low-speed scan printing are preferably determined as appropriate according to the composition, type, and the like of the inks to be used. To properly fix the image α including a high-duty (120% duty or higher) matrix with the heating unit 56, the heating time is preferably increased to be about 1.4 times the heating time in the normal printing mode. Here, in this embodiment, the movement speed of the conveyance belt 253 and the ink ejection frequency of the print heads 220 set in the low-speed printing mode are set to be (1/1.4) times those in the case of implementing the normal printing mode. While the image α passes through the heating unit 56, the image β is printed in the low-speed printing mode, in which the scan speed is (1/1.4) times the scan speed in the high-speed printing mode.

As described above, with the full line-type printing apparatus too, the heating time at the heating unit can be made longer for a predetermined region with a large ink application amount. Thus, it is possible to remedy the issue of defective scratch resistance. Further, after an image including a high-duty region finishes passing through the heating unit, the printing mode returns to the normal printing mode. This makes it possible to minimize the decrease in productivity.

### Further Embodiments

In each of the foregoing embodiments, a description has been given of a specific example of changing the printing mode to one in which the heating time at the heating unit is longer for a predetermined region with a large ink application amount in order to remedy the issue of defective scratch resistance. However, the printing mode in which the heating time at the heating unit is longer is not limited to those described in the foregoing embodiments. Specifically, the printing mode is not limited to ones that control the heating time at the heating unit by changing the number of scans of the print heads, the ink ejection frequency, the wait time, the printing scan direction, the movement speed of the print medium, or the like as in the foregoing embodiments. For example, in a case of performing multipass printing, the heating time at the heating unit can be controlled also by controlling the speed of the intermittent movement of the print medium in the sub-scanning direction.

Further, printing modes each using a combination of several types of control, such as a combination of the number of scans of the print heads and the wait time, may be prepared, and the printing mode may be switched as appropriate according to the heating time required.

Also, in each of the foregoing embodiments, an example has been described in which a single ink application ratio (duty) is set as a threshold value and whether a predetermined region in an image is a high-duty region or a low-duty region is determined based on whether its duty is less than the threshold value. Specifically, a 120% duty, which is based on test results, is set as a threshold value, and whether the predetermined region is a high-duty region or a low-duty region is determined based on whether its duty is less than the threshold value. Alternatively, a plurality of ink application ratio threshold values can be set. For example, two threshold values, e.g., a 100% duty and a 120% duty, may be set. In this case, control may be performed in which if the duty of the image α entering the heating unit is lower than 100%, an image is completed with four main scans, if the duty of the region is higher than or equal to 100% and lower than 120%, the image is completed with six main scans, and if the duty of the image α is 120% or higher, the image is completed with eight main scans. Similarly, three or more threshold values can be set as well. Providing a plurality of threshold values and changing the printing mode in a stepwise manner as above allows more appropriate heating of the image to be printed. Accordingly, the decrease in productivity can be suppressed more appropriately as well.

Also, in each of the foregoing embodiments, an example has been shown in which the printing mode is switched based on the ink application amount on the print medium. Alternatively, the printing mode may be switched based on the ink type. For example, the printing mode may be switched based on the type or amount of the fine resin particles contained in the inks or another condition that affects the ink film formability. In addition, in each of the foregoing embodiments, an example has been shown in which the printing mode is switched based on the total number of dots printed in each predetermined region, specifically, the total number of dots printed with all inks used (total dot number). However, the method is not limited to the above. For example, the printing mode may be switched based on a preset specific type of total dot number (total ink application amount). Further, an individual application amount threshold value may be set for each of the plurality of types of ink to be used, and the printing mode may be switched to the one in which the heating time at the heating unit is longer if at least one of the plurality of types of inks reaches or exceeds the corresponding threshold value.

Meanwhile, depending on the amount of the fine resin particles contained and/or another material(s), the scratch resistance of some inks drops particularly easily. In a case of using such inks, the printing mode may be switched based on the presence or absence of ejection data on the inks, the area of the image to be formed with the inks, or the like.

Also, in each of the foregoing embodiments, an example has been shown in which the printing mode is changed to the one in which the heating time at the heating unit is longer (second printing mode) immediately before a predetermined region with a large ink application amount enters the heating unit, and is returned to the original printing mode (first printing mode) immediately after the predetermined region exits the heating unit. However, the control is not limited to the one in which the printing mode is switched between two modes. Three or more printing modes can be used to switch the heating time at the heating unit in a stepwise manner. For example, the printing mode can be switched from the 6-pass printing mode to the 8-pass printing mode at a position slightly before (upstream of) the heating unit, and changed again to the 12-pass printing mode immediately before the entry into the heating unit. Alternatively, for example, the printing mode may be switched immediately before the entry into the heating unit from the 6-pass printing mode implemented before the entry to the 8-pass printing mode, and switched further to the 12-pass printing mode at a predetermined timing during the passage through the heating unit. Further, control can be performed in which the number of passes is reduced in a stepwise manner in the course of the passage of an image through the heating unit until the exit from the heating unit.

Alternatively, control in which the wait time for the heads or the movement speed of the heads is changed in a stepwise manner may be employed.

Also, in each of the foregoing embodiments, an example in which a plurality of types of inks are ejected has been shown. However, the present disclosure is applicable also to printing apparatuses that eject one type of ink.

Further, the configuration and number of print heads included in the printing apparatus are not limited to those in the examples shown in the foregoing embodiments.

Furthermore, in the foregoing embodiments, examples have been shown in which printing is performed using inks containing fine resin particles. However, the inks to be used are not limited to the above. Specifically, even in a case of forming an image with inks containing no fine resin particles, the conveyance speed of the print medium may be controlled so as to sufficiently heat an image including a high-duty predetermined region at the heating unit. Doing so can enhance the fixing of the inks and is therefore effective. In other words, the control in each of the foregoing embodiments is effective regardless of the ink type.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-017180, filed Feb. 4, 2020, which is hereby incorporated by reference wherein in its entirety.

What is claimed is:

1. A printing apparatus comprising:
a conveyance unit configured to convey a print medium in a conveyance direction;
a printing unit configured to print an image by applying ink onto the print medium;
a heating unit that is disposed downstream of the printing unit in the conveyance direction and configured to heat the print medium onto which the ink has been applied by the printing unit;
an obtaining unit configured to obtain, for each print region of a plurality of print regions on the print medium lying side by side in the conveyance direction, a piece of application information indicating an amount of ink to be applied to the print region, wherein the plurality of print regions includes a first print region and a second print region, each indicated by a corresponding piece of application information; and
a control unit configured to control, based on the pieces of application information, a printing operation to be performed by the printing unit to print images onto the plurality of print regions,
wherein the conveyance unit conveys the print medium such that the printing unit is able to print the image onto the second print region at a printing position when the heating unit is able to heat the first print region at a heating position,
wherein, in a case where the amount of ink applied to the first print region indicated by the corresponding piece of application information is a first amount, the control unit controls the printing operation to print the image onto the second print region in a first printing mode,
wherein, in a case where the amount of ink applied to the first print region indicated by the corresponding piece of application information is a second amount larger than the first amount, the control unit controls the printing operation to print the image onto the second print region in a second printing mode,
wherein each region onto which an image is printed in a printing mode is a predetermined region, and
wherein a time for which the first print region passes through the heating position in a case where the image is printed onto the second print region in the second printing mode is longer than a time for which the first print region passes through the heating position in a case where the image is printed onto the second print region in the first printing mode.

2. The printing apparatus according to claim 1, wherein each of the pieces of application information is information indicating at least one of the following: a type of ink, an area of the corresponding predetermined region, or an amount of fine resin particles contained in the ink.

3. The printing apparatus according to claim 1,
wherein the printing unit performs printing on the print medium by performing a main scan in which the printing unit moves in a direction crossing the conveyance direction, while ejecting the ink during the main scan,
wherein the first printing mode is a printing mode in which the printing unit completes printing an image to be printed in a single main scan region to be subjected to the main scan by performing the main scan a predetermined number of times on the main scan region, and
wherein the second printing mode is a printing mode in which the printing unit completes printing the image to be printed in the main scan region by performing the main scan a number of times that is greater than the predetermined number of times.

4. The printing apparatus according to claim 3,
wherein the control unit changes a wait time in the second printing mode in a stepwise manner according to a position of the predetermined region where the amount of ink applied is a predetermined value or greater, and
wherein the position of the predetermined region is a position relative to the heating unit.

5. The printing apparatus according to claim 4,
wherein among a predetermined number of print regions lying side by side on an upstream side of the second print region in the conveyance direction, the control unit makes the wait time longer for a downstream print region located more distant toward the downstream side than those print regions upstream of the downstream print region, and
wherein among a predetermined number of the print regions lying side by side on a downstream side of the first print region in the conveyance direction, the control unit makes the wait time longer for an upstream print region located more distant toward an upstream side than those print regions downstream of the upstream print region.

6. The printing apparatus according to claim 1,
wherein the first printing mode is a printing mode in which a predetermined wait time is provided from after the printing unit performs a main scan a predetermined number of times until the printing unit starts a next main scan, and
wherein the second printing mode is a printing mode in which a wait time that is longer than the predetermined wait time is provided from after the printing unit performs the main scan the predetermined number of times until the printing unit starts the next main scan.

7. The printing apparatus according to claim 1,
wherein the conveyance unit conveys the print medium in the conveyance direction between a plurality of main scans performed by the printing unit,
wherein the first printing mode is a printing mode involving a conveyance operation by the conveyance unit to convey the print medium at a predetermined conveyance speed, and
wherein the second printing mode is a printing mode in which the print medium is conveyed by the conveyance unit at a lower speed than the predetermined conveyance speed.

8. The printing apparatus according to claim 7,
wherein the first printing mode is a printing mode in which the image is printed by ejecting the ink in both a forward scan in which the printing unit moves in a forward direction and a backward scan in which the printing unit moves in a backward direction that is backward relative to the forward direction among the plurality of main scans performed by the printing unit, and
wherein the second printing mode is a printing mode in which the image is printed by ejecting the ink only in one of the forward scan and the backward scan among the plurality of main scans.

9. The printing apparatus according to claim 1,
wherein the conveyance unit continuously conveys the print medium in the conveyance direction,
wherein the printing unit includes an ejection opening array that are ejection openings for ejecting the ink arrayed in a direction crossing the conveyance direction, and wherein the printing unit is configured to print the image by ejecting the ink from the ejection opening array onto the print medium conveyed continuously,
wherein the first printing mode is a printing mode in which the image is printed with the ink ejected from the ejection opening array onto the print medium conveyed at a predetermined speed by the conveyance unit, and
wherein the second printing mode is a printing mode in which printing is performed with the ink ejected from the ejection opening array onto the print medium conveyed at a speed that is lower than the predetermined speed at which the conveyance unit conveys the print medium.

10. The printing apparatus according to claim 1, wherein the ink is an ink containing fine resin particles having a property that results in an image performance characteristic that is improved over an image performance characteristic of an ink not containing the property of the fine resin particles.

11. A method for a printing apparatus having a printing unit configured to print an image by applying ink onto a print medium, and having a heating unit that is disposed downstream of the printing unit in a conveyance direction and configured to heat the print medium onto which the ink has been applied by the printing unit, the method comprising:
conveying the print medium in the conveyance direction;
obtaining, for each print region of a plurality of print regions on the print medium lying side by side in the conveyance direction, a piece of application information indicating an amount of ink to be applied to the print region, wherein the plurality of print regions includes a first print region and a second print region, each indicated by a corresponding piece of application information; and
controlling, based on the pieces of application information, a printing operation to be performed by the printing unit to print images onto the plurality of print regions,
wherein conveying includes conveying the print medium such that the printing unit is able to print the image onto the second print region at a printing position when the heating unit is able to heat the first print region at a heating position,
wherein, in a case where the amount of ink applied to the first print region indicated by the corresponding piece of application information is a first amount, controlling includes controlling the printing operation to print the image onto the second print region in a first printing mode,
wherein, in a case where the amount of ink applied to the first print region indicated by the corresponding piece of application information is a second amount larger than the first amount, controlling includes controlling the printing operation to print the image onto the second print region in a second printing mode,
wherein each region onto which an image is printed in a printing mode is a predetermined region, and
wherein a time for which the first print region passes through the heating position in a case where the image is printed onto the second print region in the second printing mode is longer than a time for which the first print region passes through the heating position in a case where the image is printed onto the second print region in the first printing mode.

12. A non-transitory computer-readable storage medium storing a program to cause a computer to perform a method for a printing apparatus having a printing unit configured to print an image by applying ink onto a print medium, and having a heating unit that is disposed downstream of the printing unit in a conveyance direction and configured to heat the print medium onto which the ink has been applied by the printing unit, the method comprising:
conveying the print medium in the conveyance direction;
obtaining, for each print region of a plurality of print regions on the print medium lying side by side in the conveyance direction, a piece of application information indicating an amount of ink to be applied to the print region, wherein the plurality of print regions includes a first print region and a second print region, each indicated by a corresponding piece of application information; and
controlling, based on the pieces of application information, a printing operation to be performed by the printing unit to print images onto the plurality of print regions,
wherein conveying includes conveying the print medium such that the printing unit is able to print the image onto the second print region at a printing position when the heating unit is able to heat the first print region at a heating position,
wherein, in a case where the amount of ink applied to the first print region indicated by the corresponding piece of application information is a first amount, controlling includes controlling the printing operation to print the image onto the second print region in a first printing mode,
wherein, in a case where the amount of ink applied to the first print region indicated by the corresponding piece of application information is a second amount larger than the first amount, controlling includes controlling the printing operation to print the image onto the second print region in a second printing mode,
wherein each region onto which an image is printed in a printing mode is a predetermined region, and
wherein a time for which the first print region passes through the heating position in a case where the image is printed onto the second print region in the second printing mode is longer than a time for which the first print region passes through the heating position in a case where the image is printed onto the second print region in the first printing mode.
